(19) United States
(12) Patent Application Publication
(10) Pub. No.: US 2009/0274389 A1
(43) Pub. Date: Nov. 5, 2009

(54) IMAGE PROCESSOR, INTEGRATED CIRCUIT DEVICE, AND ELECTRONIC APPARATUS

(75) Inventor: Takekuni YAMAMOTO, Suwa-gun (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/426,596

(22) Filed: Apr. 20, 2009

(30) Foreign Application Priority Data
Apr. 30, 2008 (JP) 2008-118596

(51) Int. Cl. G06K 9/40

(52) U.S. Cl. 382/274

(57) ABSTRACT

An image processor includes a statistic-data acquiring section acquiring statistic data of a luminance value of a displayed image, the statistic-value acquiring section acquires, as the statistic data, a first index regarding a shadow pixel group and a second index regarding a highlight pixel group; a brightness index computing section computing a brightness index of the displayed image based on the statistic data, the brightness index computing section computing the brightness index from the first and the second indexes; a filtering section filtering luminance values of at least a part of a plurality of pixels included in a target pixel region of the displayed image to compute a local average luminance value; and a contrast correcting section performing contrast correction of the displayed image based on the brightness index and the local average luminance value.

The entire disclosure of Japanese Patent Application No. 2008-118596, filed Apr. 30, 2008 is expressly incorporated by reference herein.

### BACKGROUND

1. Technical Field

An aspect of the present invention relates to an image processor, an integrated circuit device, and an electronic apparatus.

2. Related Art

When capturing a static or moving image by a digital camera or the like, an image quality obtained may be deteriorated depending on image-capturing conditions. In general, to record and reproduce such captured static or moving images in as good a quality as possible, image processing is performed. The image processing includes contrast correction. The contrast correction allows gradation data of a captured image to be corrected in such a way that contrast of the image is readily perceivable by human eyes.

When correcting image contrast, statistic data is first extracted from the image, and then a correction value is computed based on the statistic data. One critical issue in determining characteristics of contrast correction is to appropriately determine what kind of statistic data should be used. In some cases, depending on statistic data selected, no correction effect can be seen on the image. Additionally, for an originally good quality image, high contrast correction is undesired.

Meanwhile, regarding mobile apparatuses such as mobile phones, battery operating time is a major concern among users and is an important factor in design of the apparatuses. Accordingly, even components incorporated in the mobile apparatuses are required to operate at low power. Among the components, a backlight unit for a liquid crystal panel consumes a large amount of power. Power consumption can be reduced by dimming (reducing) backlight in accordance with luminance or the like of a moving or static image displayed.

However, dimming backlight leads to reduction in luminance and chroma of the displayed image. Thus, JP-A-2006-308631 has disclosed an example of an image processor capable of preventing image quality deterioration by correcting the luminance and chroma of displayed images in accordance with backlight dimming. In the image processor, for example, when correcting the luminance, luminance in data of a displayed image is enhanced to compensate for reduced visual luminance due to backlight dimming.

However, in that case, enhancing the luminance highly leads to loss of gradation data regarding high-luminance pixels. As a result, while backlight dimming contributes to power consumption reduction, contrast (gradation) of a highlight portion in the image is lost.

### SUMMARY

An advantage of the present invention is to provide an image processor capable of performing appropriate contrast correction, and another advantage of the invention is to provide an integrated circuit device and an electronic apparatus including the image processor.

An image processor according to a first aspect of the invention includes a statistic-data acquiring section acquiring statistic data of a luminance value of a displayed image, the statistic-value acquiring section acquires, as the statistic data, a first index regarding a shadow pixel group and a second index regarding a highlight pixel group; a brightness index computing section computing a brightness index of the displayed image based on the statistic data, the brightness index computing section computing the brightness index from the first and the second indexes; a filtering section filtering luminance values of at least a part of a plurality of pixels included in a target pixel region of the displayed image to compute a local average luminance value; and a contrast correcting section performing contrast correction of the displayed image based on the brightness index and the local average luminance value.

The image processor of the first aspect performs contrast correction using the brightness index obtained from the indexes regarding the shadow pixel group and the highlight pixel group. Thereby, even when there is a deviation in luminance distribution of the displayed image, contrast can be evenly improved for a low-luminance image region and a high-luminance image region. For a high-quality image where most pixels are distributed on a medium-luminance region, the brightness index can be set to a luminance value near a center of the luminance distribution, so that the high-quality image can maintain high contrast. Additionally, since the image processor performs contrast correction using the local average luminance value, contrast of the displayed image as a whole can be corrected while maintaining local contrast. Furthermore, as will be described below, the image processor can perform contrast correction allowing a dynamic range of the displayed image to be compressed, thereby preventing contrast deterioration of a highlight portion due to enhancement of luminance. Thus, using the brightness index allows the contrasts of the low- and the high-luminance regions to be evenly improved, whereby contrast deterioration of the highlight portion can be prevented, as well as contrast of the shadow portion can be improved.

According to a first preferred feature of the first aspect, in the image processor of the first aspect, the first index is a maximum luminance value in a range where a value obtained by adding numbers of the pixels included in the displayed image in ascending numeric order of the luminance values does not exceed a first threshold value, and the second index is a minimum luminance value in a range where a value obtained by adding the numbers of the pixels included in the displayed image in descending numeric order of the luminance values does not exceed a second threshold value.

Thereby, there can be obtained the first index regarding the shadow pixel group and the second index regarding the highlight pixel group. In the image processor, the numbers of the pixels are added in the ascending and the descending numeric orders, respectively, of the luminance values, thereby obtaining the respective indexes corresponding to the shadow portion and the highlight portion, respectively.

According to a second preferred feature of the first aspect, in the image processor of the first aspect, the brightness index is an average between the first and the second indexes.

Thereby, the brightness index can be obtained using the first and the second indexes. Using the average between the first and the second indexes allows contrast correction to be evenly performed for the high- and the low-luminance image regions.

According to a third preferred feature of the first aspect, the image processor of the first aspect further includes an adding section adding the luminance value of each of the at least a part of the pixels included in the displayed image and a correction value; the target pixel region includes at least one target pixel of the displayed image; the contrast correcting section outputs a first correction value obtained from a difference between the brightness index and the local average luminance value; and the adding section adds a luminance value of the at least one target pixel and the first correction value.

Thereby, image processing of the displayed image can be performed through contrast correction by the image processor of the first aspect. Additionally, since the correction value is obtained from the difference between the brightness index and the local average luminance value, the contrast correction can be accomplished using the brightness index and the local average luminance value.

According to a fourth preferred feature of the first aspect, in the above image processor, when the local average luminance value is smaller than the brightness index, the contrast correcting section outputs, as the first correction value, a correction value that increases the luminance value of the at least one target pixel, whereas, when the local average luminance value is larger than the brightness index, the contrast correcting section outputs, as the first correction value, a correction value that decreases the luminance value of the at least one target pixel.

Thereby, the image processor can perform the contrast correction that increases the luminance of the low-luminance region in the displayed image and decreases the luminance of the high-luminance region in the image. Thus, the contrast correction allows the dynamic range compression of the image to be accomplished.

According to a fifth feature of the first aspect, in the above image processor, the contrast correcting section outputs, as the first correction value, a correction value whose absolute value increases as an absolute value of the difference between the brightness index and the local average luminance value increases.

Thereby, the image processor can perform the contrast correction that increases the luminance of the image region in the displayed image as the luminance decreases and that decreases the luminance of the region as the luminance increases. As a result, the contrast correction allows the dynamic range compression of the displayed image to be accomplished.

According to a sixth preferred feature of the first aspect, the image processor of the first aspect further includes an adding section adding the luminance value of each of the at least a part of the pixels included in the displayed image and a correction value; the target pixel region is a region including at least one target pixel in the displayed image; the contrast correcting section includes a converting section performing a processing of converting the local average luminance value by using the brightness index to output a converted local average luminance value and outputs a first correction value by using the local average luminance value and the converted local average luminance value; and the adding section adds a luminance value of the at least one target pixel and the first correction value.

Thereby, there can be obtained the first correction value for performing the contrast correction using the brightness index and the local average luminance value. In addition, with the conversion processing, there can be obtained the first correction value from the difference between the brightness index and the local average luminance value.

According to a seventh preferred feature of the first aspect, in the above image processor, when the local average luminance value is smaller than the brightness index, the converting section performs the conversion processing such that the converted local average luminance value becomes larger than the local average luminance value, whereas, when the local average luminance value is larger than the brightness index, the converting section performs the conversion processing such that the converted local average luminance value becomes smaller than the local average luminance value.

Thereby, the first correction value can be obtained that allows the dynamic range of the image to be compressed without losing local contrast.

According to an eighth preferred feature of the first aspect, the image processor of the sixth preferred feature of the aspect further includes a correction adjustment register setting a first correction intensity corresponding to the local average luminance value having a higher luminance level than the brightness index and a second correction intensity corresponding to the local average luminance value having a lower luminance level than the brightness index.

In this manner, the contrast correction intensity can be set. In addition, the correction intensity can be independently set for each of the low- and the high-luminance regions of the displayed image.

According to a ninth preferred feature of the first aspect, in the above image processor, when the local average luminance value is larger than the brightness index, the converting section multiplies a difference between the brightness index and the local average luminance value by the first correction intensity, whereas, when the local average luminance value is smaller than the brightness index, the converting section multiplies the difference between the brightness index and the local average luminance value by the second correction intensity.

Thereby, the intensity of the contrast correction can be adjusted using the correction intensities set as above. In addition, the correction intensity adjustment can be independently performed for each of the low- and the high-luminance regions of the displayed image.

According to a tenth preferred feature of the first aspect, the image processor of the sixth preferred feature of the aspect further includes a contrast adjustment offset computing section outputting a first offset that adjusts an offset for a low-luminance side in the conversion processing and a second offset that adjusts an offset for a high-luminance side in the conversion processing.

Thereby, offset adjustment in the contrast correction can be performed. For example, the first offset can enhance a low-luminance side of the first correction value and can dim a high-luminance side thereof. In addition, the second offset can dim the low-luminance side of the first correction value and can enhance the high-luminance side thereof. Furthermore, the second offset can prevent image quality of a highlight portion from being deteriorated due to the luminance enhancement.

According to an eleventh feature of the first aspect, in the above image processor, the statistic-value acquiring section acquires an average luminance value of the displayed image as the statistic data; the brightness index computing section outputs a brightness difference value as an absolute value of a difference value between the brightness index and the local average luminance value; and the contrast adjustment offset computing section outputs the first and the second offsets by using the brightness difference value.

Thereby, in a displayed image having a deviated luminance distribution, image quality deterioration of the highlight portion due to luminance enhancement can be prevented. In addition, contrast of a low-luminance region with many of the pixels can be further enhanced.

According to a twelfth preferred feature of the first aspect, the image processor of the tenth preferred feature of the aspect further includes a correction adjustment register setting a first offset adjustment value and a second offset adjustment value, and the contrast adjustment offset computing section outputs the first offset by using the first offset adjustment value and outputs the second offset by using the second offset adjustment value.

Thereby, the first and the second offsets can be adjusted. Then, the first offset for the low-luminance side and the second offset for the high-luminance side each can be independently adjusted.

According to a thirteenth preferred feature of the first aspect, in the above image processor, the correction adjustment register sets a first correction intensity corresponding to the local average luminance value having a higher luminance level than the brightness index and a second correction intensity corresponding to the local average luminance value having a lower luminance level than the brightness index; and the converting section performs a multiplication in which, when the local average luminance value is larger than the brightness index, the difference value between the brightness index and the local average luminance value is multiplied by the first correction intensity, whereas when the local average luminance value is smaller than the brightness index, the difference value between the brightness index and the local average luminance value is multiplied by the second correction intensity, so as to add a result of the multiplication to the first offset.

In the above image processor, the converting section performs an offset addition processing for adding the first offset to the multiplication result of the correction intensities. Thereby, the offset of the low-luminance side in the conversion processing can be adjusted.

According to a fourteenth feature of the first aspect, in the image processor of the third preferred feature of the aspect, when an absolute value of a difference value between the luminance value of the at least one target pixel and the local average luminance value is smaller than a predetermined value, the contrast correcting section uses the luminance value of the at least one target pixel instead of the local average brightness value.

Thereby, without increasing computation precision of the local average luminance value, the contrast correction can be accomplished that enhances low-gradation contrast. In addition, the above structure can prevent an increase in a circuit scale due to increased computation precision.

According to a fifteenth preferred feature of the first aspect, the image processor of the third preferred feature of the aspect further includes a dimming correcting section outputting a dimming amount for performing dimming correction of image display lighting in accordance with the displayed image and a brightness enhancement correcting section outputting a second correction value for luminance enhancement based on the dimming amount; and the adding section adds the luminance value of the at least one target pixel to the second correction value.

In the above image processor, dimming the image display lighting can reduce power consumption. In addition, enhancing the luminance in accordance with the dimming amount can compensate for reduction in the luminance of the displayed image due to the dimming. Furthermore, compressing the dynamic range of the image by the contrast correction can prevent image quality deterioration of the highlight portion due to luminance enhancement. As a result, dimming of the image display lighting can be accomplished while maintaining good image quality, as well as power consumption can be reduced by the dimming.

An integrated circuit device according to a second aspect of the invention includes the image processor of the first aspect.

An electronic apparatus according to a third aspect of the invention includes the integrated circuit device of the second aspect.

### BRIEF DESCRIPTION OF THE DRAWINGS

The invention will be described with reference to the accompanying drawings, wherein like numbers reference like elements.

FIGS. 1A to 1C are illustrations of lighting control and results of image correction due to the lighting control.

FIGS. 2A and 2B are characteristic charts of the mage correction due to the lighting control.

FIG. 3 is a diagram showing a structural example of an image processor according to an embodiment of the invention.

FIG. 4 is an illustration of contrast correction.

FIG. 5 is another illustration of the contrast correction.

FIGS. 6A-1 and 6A-2 and FIGS. 6B-1 to 6B-3 are illustrative charts of relationships between contrast correction and image correction due to lighting control.

FIG. 7 is a specific example of a luminance index.

FIGS. 8A and 8B are diagrams showing an image example for a luminance index explanation.

FIG. 9A is an example of contrast correction using a comparative example of a luminance index.

FIG. 9B is an example of contrast correction using a specific example of a luminance index.

FIG. 10 is a detailed structural example of the image processor according to the embodiment.

FIGS. 11A and 11B are charts illustrating a conversion section.

FIG. 12 is a chart showing a correction value as a first specific example.

FIG. 13A is a chart showing a correction value as a second specific example.

FIG. 13B is a chart illustrating a relationship between the correction value as the second specific example and image correction due to lighting control.

FIGS. 14A and 14B are charts showing a level correction

FIG. 15 is a histogram showing an image example obtained by applying the image processor of the embodiment.

FIG. 16 is a diagram showing a structural example of an integrated circuit device.

FIG. 17 is a detailed structural example of the integrated circuit device.

FIG. 18 is a diagram showing a structural example of an electronic apparatus.

FIG. 19 is a characteristic chart of lighting control and image correction due the lighting control.

### DESCRIPTION OF EXEMPLARY EMBODIMENTS

Embodiments of the invention will be described in detail with reference to the drawings. A present embodiment described below does not unduly restrict the content of the invention as defined in the scope of claims. In addition, not all of structures described in the present embodiment are essential for the invention to solve the above conventional problems.

For simplified description, a description hereinafter will be given of an example of the embodiment performing image correction (luminance enhancement) in accordance with adjustment (dimming) of backlight for a liquid crystal panel. In this case, an image processor of the embodiment performs correction for compressing a dynamic range of luminance while maintaining contrast of a displayed image (a frame image) to prevent deterioration of image quality caused by the image correction in accordance with the backlight dimming. Then, the image processor can appropriately perform contrast correction by using a brightness index obtained from statistic data.

The image processor of the embodiment may perform only contrast correction or may perform contrast correction combined with any other image correction for expanding the dynamic range. In addition, the contrast correction may be performed without compression of the luminance dynamic range or together with expansion of the dynamic range. Furthermore, the image processor is applicable to processing of not only display images of liquid crystal panels but those of display panels using an electro luminescence (EL) light emitting element, for example. Still furthermore, the image processor can be used for image recording and the like, in addition to display of images.

Next will be described the image correction in accordance with the backlight dimming and problems associated with the correction, and then the embodiment of the invention.

1. Dimming Control and Brightness Correction Enhancement

1-1. Relationship between Dimming Control and Image Correction

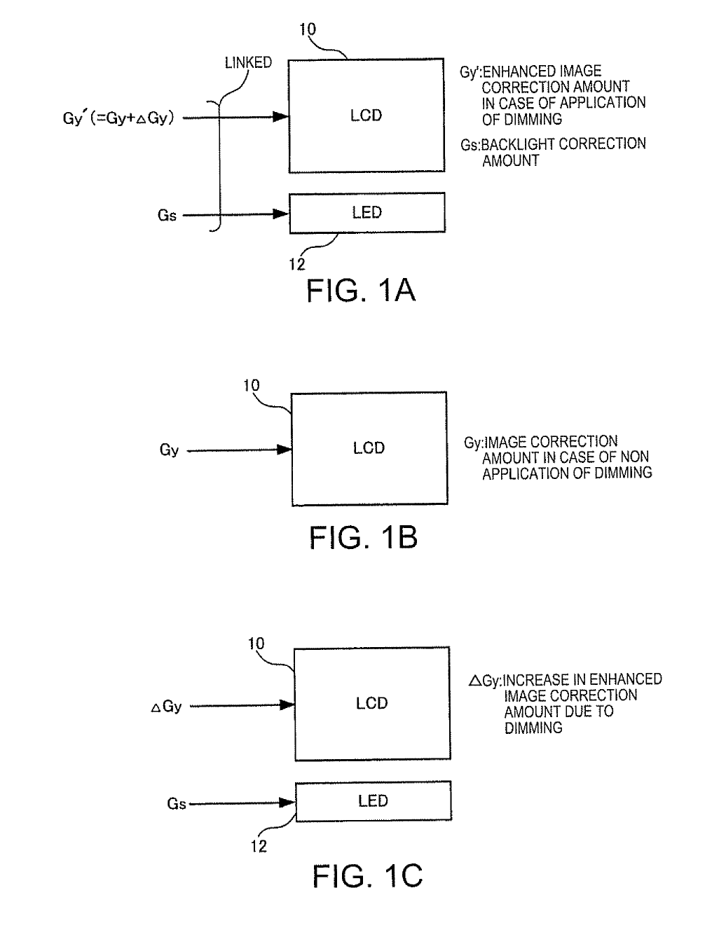

FIGS. 1A to 1C are diagrams illustrating adaptive luminance adjustment control (adaptive dimming control) and image correction for a displayed image.

As shown in FIG. 1A, an adaptive image correction of a liquid crystal panel (LCD) 10 and an adaptive luminance correction (adaptive dimming) of lighting (LED: hereinafter referred to as “backlight (BL)”) 12 are simultaneously performed. In the drawings, symbol Gy′ represents a value of image correction enhanced in a case of luminance adjustment (dimming). The image correction value Gy′ is obtained by adding Gy as a value of image correction performed in a case of no dimming to ΔGy as an increase in the image correction value enhanced due to the dimming. Symbol Gs represents a luminance correction value of the backlight 12 associated with the adaptive dimming.

FIG. 1B shows the image correction value Gy provided when no dimming is performed. In short, the image correction value Gy is a correction value provided under a condition of a fixed luminance of the backlight 12. For example, for a low-luminance portion, correction is performed to increase the luminance, whereas, for an excessively high-luminance portion, a luminance decreasing correction is performed.

FIG. 1C shows ΔGy as an increase in the image correction value in the case of dimming (Gs: the BL's luminance correction value). In general, dimming control is performed such that a dimming amount of the backlight 12 is increased upon display of dark images. This is because dark images are less influenced by dimming than bright images. On the other hand, visual luminance of a displayed image is reduced due to dimming. Accordingly, image correction is enhanced (hereinafter referred to as “brightness correction enhancement”) to compensate for the luminance reduction.

In image correction enhanced in response to dimming, as shown in FIG. 1A, light of the backlight 12 is dimmed down as much as possible to reduce power consumption. In addition, the increase ΔGy in the brightness correction enhancement in response to the dimming (Gs) is added to the ordinary image correction value Gy to prevent image quality deterioration due to the dimming. As a result, the Gy′ as a final image correction value can be determined.

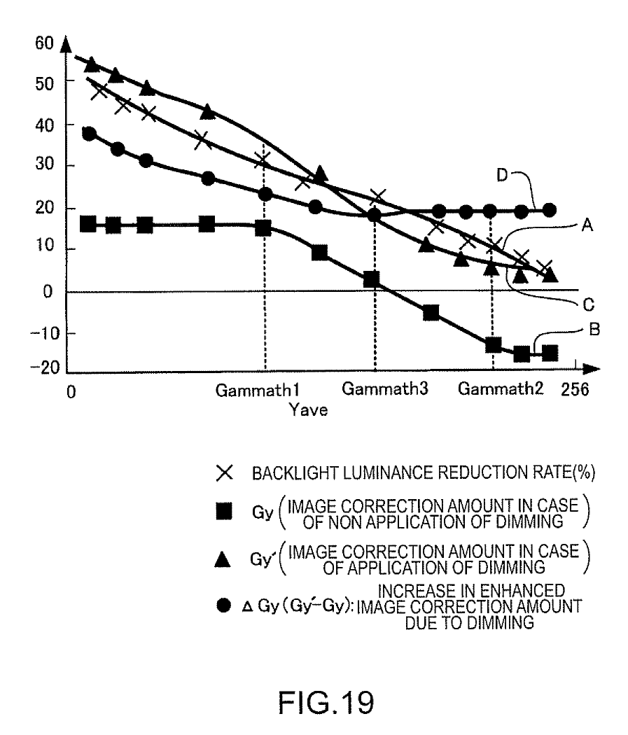

FIG. 19 shows a characteristic chart showing changes of a backlight luminance reduction rate, of the image correction value Gy in the case of no dimming, of the image correction value Gy′ in the case of dimming, and of the increase ΔGy in the image correction value due to the dimming, with respect to changes in an average luminance Yave of a single flame image.

In the drawing, characteristic lines A and B, respectively, indicate characteristics of the backlight luminance reduction rate (%) and of the image correction value Gy without dimming, respectively. Additionally, characteristic lines C and D, respectively, indicate characteristics of the image correction value Gy′ along with dimming and of the increase ΔGy in the image correction value along with the dimming, respectively.

A first attention will be focused on the characteristic line A indicating the changes in the backlight luminance reduction rate. As obvious in the chart, as lower the average luminance Yave, the higher the backlight luminance reduction rate. The backlight reduction rate is reduced as the average luminance Yave becomes higher. This is due to a following reason. An image having a higher average luminance is more influenced by dimming of backlight. Thus, for an image with a lower average luminance, a large amount of backlight is dimmed to give priority to low power consumption, whereas, for a highly luminous image, the amount of backlight dimming is made small to prioritize suppression of image quality deterioration.

Next will be focused on the characteristic line B indicating the change in the image correction value Gy without dimming. As shown in the drawing, an approximately constant amount of luminance increasing correction is performed up to an average luminance value Gammath 1. Then, as the average luminance value Yave becomes larger, an amount of luminance increased is reduced. When the value Yave becomes larger than an average luminance value Gammath 2, a luminance reducing correction is performed. In other words, basically, in a condition of low-level average luminance, correction is performed to increase the luminance, whereas, in a condition of excessively high average luminance, a luminance reducing correction is performed.

Next, the characteristic line C will be focused that indicates the change in the enhanced image correction value Gy′ due to dimming. As shown in the drawing, the lower the average luminance, the larger the image correction value, whereas the higher the average luminance, the smaller the image correction value. This is because the image correction value is determined based on the characteristic line B, as well as a part with lower luminance needs more enhancement of the image correction value to prevent image quality deterioration on the lower luminous part subjected to a large dimming rate.

Next will be described the characteristic line D indicating the change in the increase (ΔGy=Gy′−Gy) in the image correction value along with dimming. As described above, the increase ΔGy is on the increase on the low luminous part and gradually decreases as the luminance value increases. In addition, the increase ΔGy gradually increases from around an average luminance value Gammath 3. The reason for that is that, a higher luminous image can result in having a poorer image quality due to the dimming of the backlight 12, so that image correction needs to be more enhanced to suppress luminance reduction of an image having a high average luminance.

1-2. Brightness Correction Enhancement

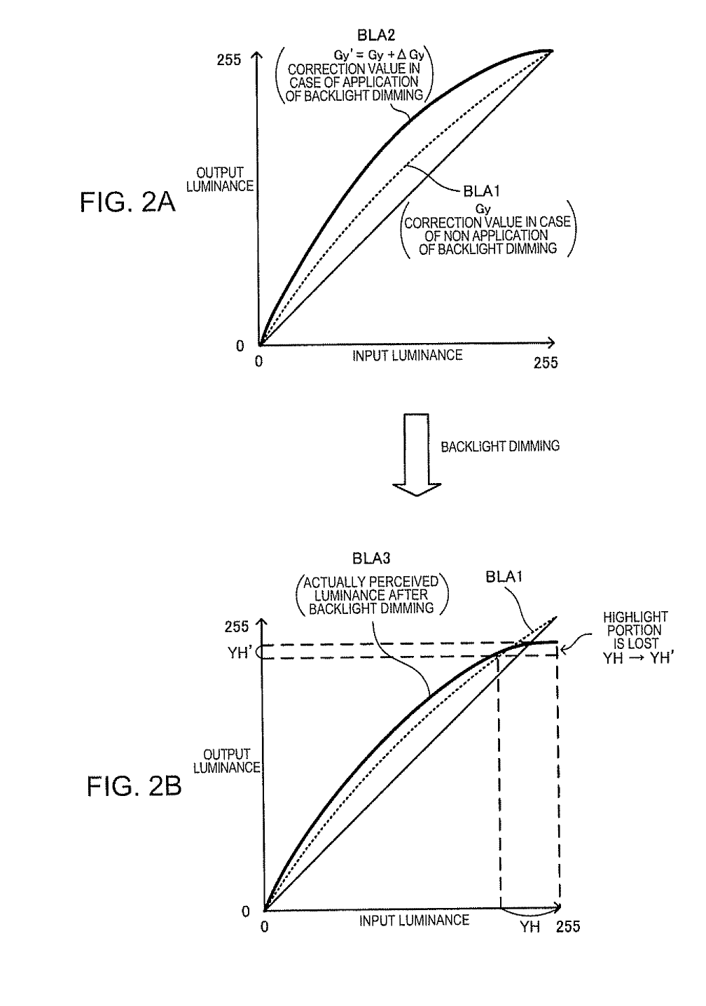

FIGS. 2A and 2B are characteristic charts of graphs illustrating output luminance relative to input luminance in a case of correcting the input luminance by the image correction value Gy′. A graph line BLA-1 indicates output luminance obtained when the input luminance is corrected by the image correction value Gy in the case of no dimming. A graph line BLA-2 indicates output luminance relative to input luminance corrected by the image correction value Gy′ that includes the image correction value Gy in the case of no dimming and an increase ΔGy in an enhanced brightness correction amount associated with dimming. In short, the graph line BLA-2 shows a correction in which the increase ΔGy in the brightness correction enhancement is added to the correction shown by the graph line BLA-1.

In a graph line BLA-3 of FIG. 2B, the output luminance of the graph line BLA-2 is represented by actually perceived luminance as a result of backlight dimming. As obvious in the graph line BLA-3, the output luminance of the graph line BLA-2 after the correction shows visual luminance reduction due to the backlight dimming.

As shown in FIG. 2B, the BLA-3 can be made into a curve close to the BLA-1 by appropriately setting the increase ΔGy in the brightness correction amount enhanced in accordance with the dimming. In other words, regardless of the application of backlight dimming (the BLA-3), using the increase ΔGy can result in image correction equivalent to correction using the image correction value Gy in the case of no dimming (the BLA-1).

In this manner, dimming-induced luminance reduction can be compensated by the brightness correction enhancement, thereby obtaining an image visually equivalent to that obtained in correction without dimming. Thus, image quality deterioration can be prevented, as well as power consumption can be reduced by dimming of backlight.

On the other hand, when luminance is significantly enhanced by the brightness correction enhancement, a contrast (gradation) of a highlight portion in a displayed image is lost. For example, as shown in FIG. 2B, when a range of the input luminance corresponding to the highlight portion is set as YH, a range of the output luminance after correction in the YH is compressed to YH′, resulting in loss of the contrast.

2. Contrast Correction

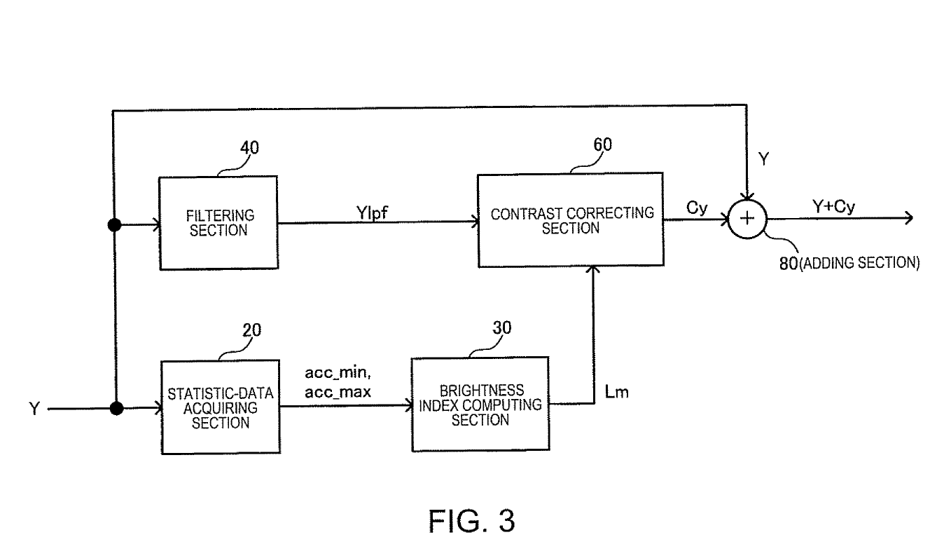

FIG. 3 shows a structural example of the image processor of the embodiment capable of solving the above problem. The image processor performs contrast correction appropriately in accordance with each displayed image. Specifically, the image processor performs contrast correction in accordance with changes in displayed images, as in moving images or the like. The contrast correction enables a dynamic range of the displayed image to be compressed, thereby preventing highlight loss due to the brightness correction enhancement.

Specifically, the image processor of the embodiment includes a statistic-data acquiring section 20, a brightness index computing section 30, a filtering section 40, and a contrast correcting section 60. The statistic-data acquiring section 20 acquires statistic data from a displayed image, and based on the statistic data, contrast correction is performed by the brightness index computing section 30, the filtering section 40, and the contrast correcting section 60.

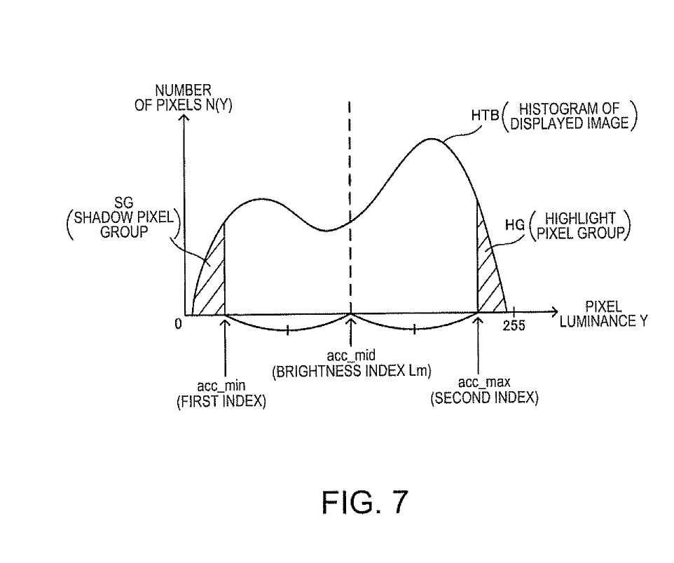

More specifically, the statistic-data acquiring section 20 acquires statistic-data regarding a pixel luminance value included in the displayed image. To explain it in more detail, the statistic-data acquiring section 20 calculates a number of pixels having respective luminance values to create a histogram and outputs the statistic data based on the histogram. For example, the statistic-data acquiring section 20 outputs a first index acc_min relating to a shadow pixel group and a second index acc_max relating to a highlight pixel group, both of which will be described below in FIG. 7.

The brightness index computing section 30 receives the statistic data from the statistic-data acquiring section 20 to output a brightness index Lm (a luminance index or a luminance statistical value). The brightness index Lm is used in the image correction performed by the image processor of the embodiment and represents a luminance value indicating a brightness of an entire displayed image. For example, the brightness index computing section 30 outputs an average value between the first index acc_min and the second index acc_max, as the brightness index Lm.

The filtering section 40 filters a luminance value of each of pixels included in a target pixel region to compute a local average luminance value Ylpf. The target pixel region is a region as a part of the displayed image and includes target pixels as objects to be corrected. For example, the filtering is calculation of an average between the luminance values of the pixels included in the target pixel region. In addition, the local average luminance value Ylpf represents an average luminance in the target pixel region.

The contrast correcting section 60 performs contrast correction (contrast compression) of the displayed image. The contrast correction is, for example, an image correction for maintaining or improving a contrast (a luminance contrast) of each of the shadow portion and the highlight portion of the displayed image and an image correction by which the dynamic range of the displayed image is compressed as a correction result. Specifically, the contrast correcting section 60 receives the brightness index Lm and the local average luminance value Ylpf to output a first correction value Cy.

Furthermore, the image processor of the embodiment may include an adding section 80. The adding section 80 performs addition of data of each pixel included in the displayed image and the correction value. Specifically, the adding section 80 adds the first correction value Cy to a luminance value Y of a target pixel to output a luminance Y+Cy of the target pixel after contrast correction.

The statistic-data acquiring section 20 can acquire statistic data from all pixels included in the displayed image or can acquire statistic data from a part of all the pixels in the displayed image. Additionally, the statistic-data acquiring section 20 can acquire the average luminance Yave (an entire-screen average luminance value) of the displayed image as statistic data. Then, the brightness index computing section 30 can output the average luminance Yave as the brightness index Lm. As a filtering processing, the filtering section 40 can assign a different weight to the luminance value of each pixel included in the target pixel region to obtain an average value. The contrast correcting section 60 can perform contrast correction without changing the dynamic range or can perform contrast correction expanding the dynamic range. Adding processing by the adding section 80 may include not only addition but subtraction or may include multiplication of coefficients.

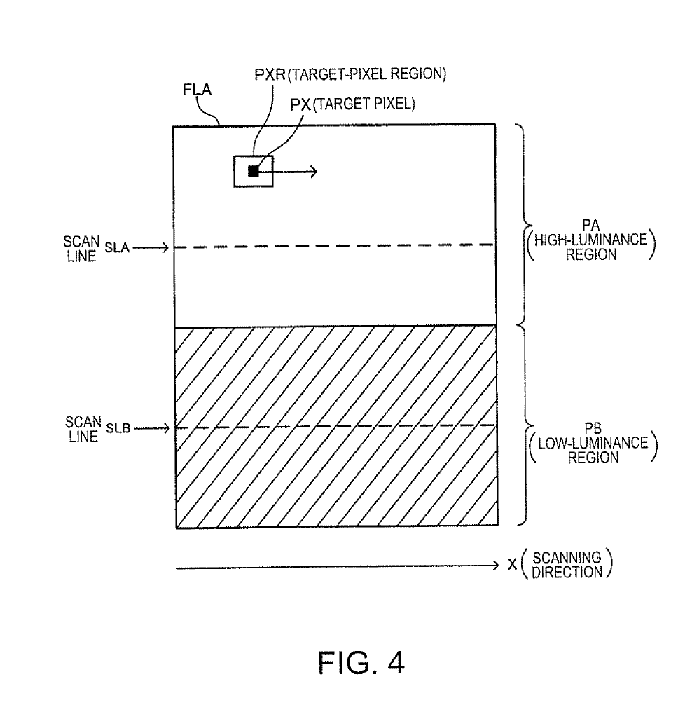

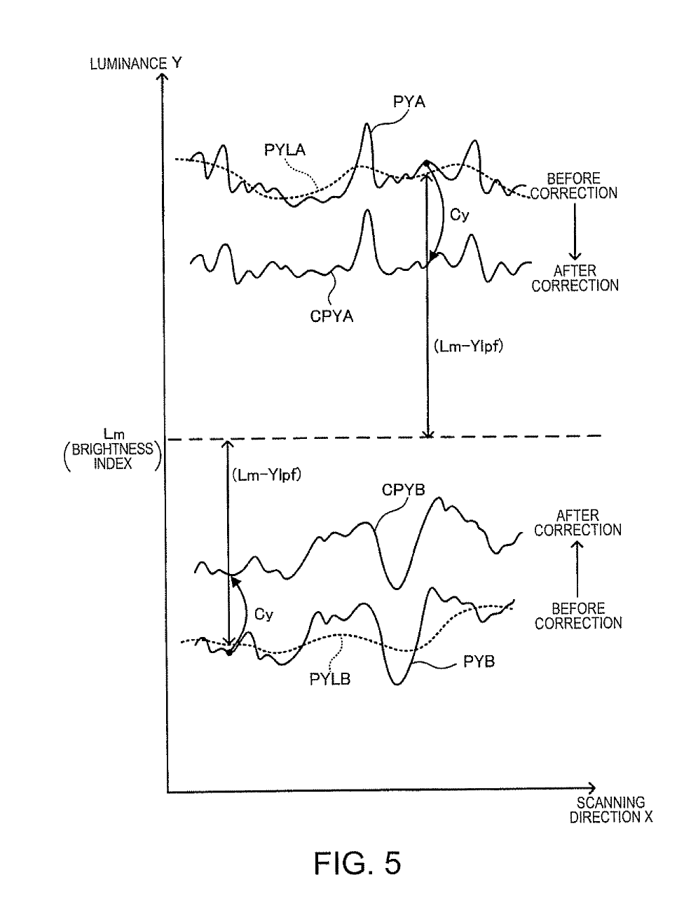

Next will be described contrast correction in detail with reference to FIGS. 4 and 5. FIGS. 4 and 5 are schematic diagrams showing the contrast correction performed by the image processor of the embodiment. For simplification of the description, there is used an example in which a displayed image FLA is divided into a high luminous region PA and a low luminous region PB. The object processed by the image processor is not restricted to the example of FIG. 4.

As shown in FIG. 4, a target pixel PX, which is each pixel included in the displayed image FLA, moves on the displayed image FLA as the displayed image FLA is scanned. A target pixel region PXR is a region moving together with the target pixel PX on the displayed image FLA. For example, around the target pixel PX as a center, there can be set a region including (2n+1) pixels×(2m+1) pixels (n and m each are a natural number).

The brightness index computing section 30 obtains the brightness index Lm corresponding to the displayed image FLA. That is, the brightness index Lm is obtained as a single value corresponding to an image displayed on a single screen. Accordingly, the brightness index Lm is changed not by scanning on the single screen but by shifting of displayed images FLA in a moving image or the like. Additionally, the filtering section 40 outputs the local average luminance value Ylpf corresponding to the target pixel region PXR. The local average luminance value Ylpf is changed in accordance with scanning on the single screen.

FIG. 5 shows a correction example regarding scan lines SLA and SLB in FIG. 4. In FIG. 5, the scan lines SLA and SLB, respectively, are located in a region PA with a higher luminance than the brightness index Lm and a region PB with a lower luminance than that, respectively.

A graph line PYA in FIG. 5 indicates luminance values Y of pixels positioned on the scan line SLA, namely the luminance values Y of the target pixels PX moving on the scan line SLA. A graph line PYLA indicates a local average luminance value Ylpf of the target pixel region PXR corresponding to the above target pixels PX. The local average luminance value Ylpf is an average luminance value of the target pixel region PXR, and thus, changes more gradually than the luminance values Y.

Then, with contrast correction, the luminance values Y indicated by the PYA are corrected to luminance values Y+Cy indicated by the CPYA. The contrast correction is performed using the brightness index Lm as a reference midpoint and based on the local average luminance value Ylpf. Specifically, in the contrast correction, the contrast correcting section 60 outputs a correction value Cy (a positive or negative correction value) corresponding to each pixel based on the brightness index Lm and the local average luminance value Ylpf. For example, the contrast correcting section 60 outputs a correction value Cy obtained based on a difference value Lm−Ylpf between the brightness index Lm and the local average luminance value Ylpf.

Similarly, a graph line PYB indicates luminance values Y of pixels on the scan line SLB, and a graph line PYLB indicates a local average luminance value Ylpf of the target pixel region PXR corresponding to the pixels on the scan line SLB. Then, the contrast correcting section 60 corrects the luminance values Y of the graph line PYB to the luminance values Y+Cy of the graph line CPYB.

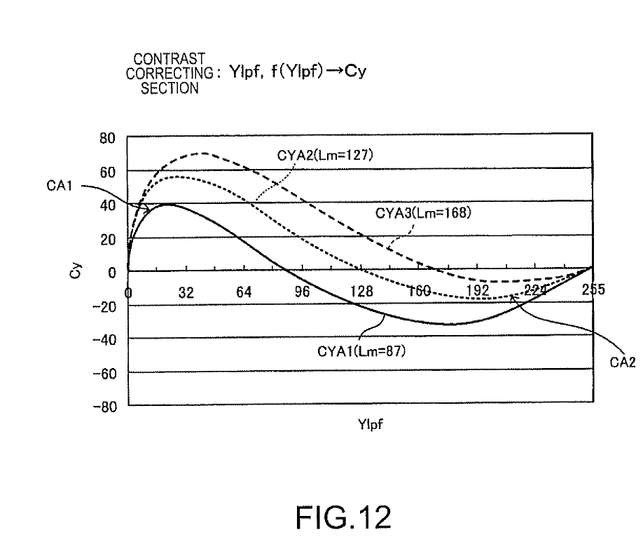

In this manner, the image processor of the embodiment performs the contrast correction of the displayed image FLA. For example, as indicated by graph lines CA-1 and CA-2 of FIG. 12 described later, the image processor can output a correction value Cy enhancing a gradation difference when the local average luminance value Ylpf is near a maximum value (e.g. 255) and near a minimum value (e.g. 0). This can improve contrasts of the highlight portion and the shadow portion in the displayed image FLA.

In addition, the image processor of the embodiment changes a dynamic range of the displayed image FLA as a result of the contrast correction. Specifically, the image processor adjusts expansion and compression of the dynamic range based on a sign (plus or minus) of the correction value Cy. For example, as shown in FIG. 5, when the difference value Lm−Ylpf has a plus sign, the contrast correcting section 60 outputs a correction value Cy (a negative correction value) for reducing luminance, whereas when the value has a minus sign, the section 60 outputs a correction value Cy (a positive correction value) increasing luminance. In addition, the contrast correcting section 60 can increase an absolute value of the correction value Cy as the local average luminance value Ylpf is farther away from the brightness index Lm. Thereby, the image processor can perform the contrast correction of the displayed image FLA and also can compress the dynamic range of the displayed image FLA.

In this case, the image processor maintains a gradation difference between pixels close to each other while compressing the dynamic range of the displayed image FLA. Specifically, the correction value Cy can be obtained using the local average luminance value Ylpf. For example, as shown in the graph line CPYA of FIG. 5, the contrast of the graph line PYA before the correction is maintained. Although FIG. 5 shows only a scanning direction of the displayed image FLA, contrast between the pixels close to each other can be maintained regardless of the direction in the displayed image FLA.

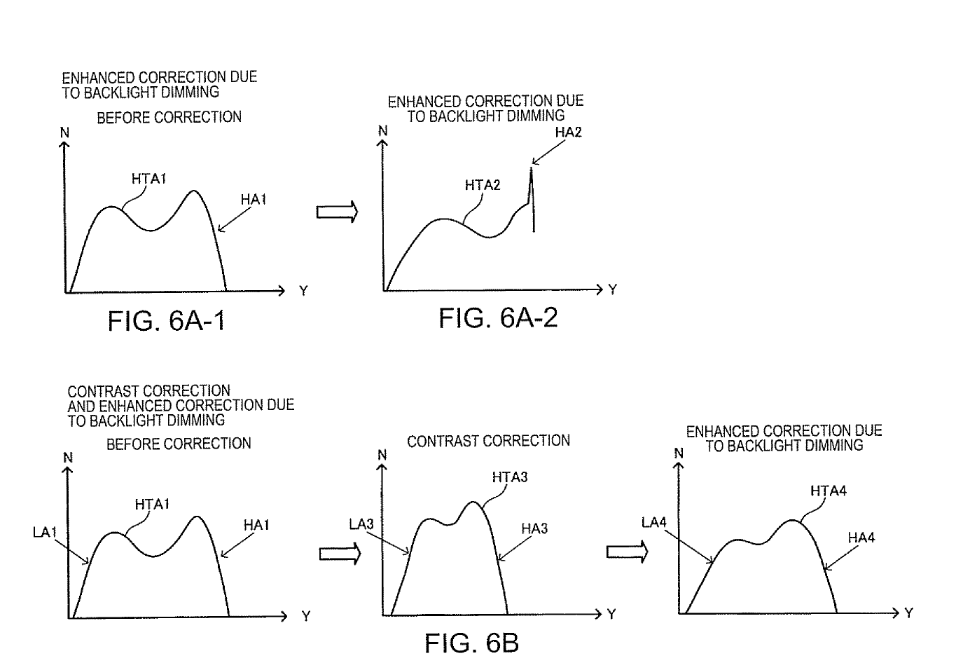

Meanwhile, as described in FIGS. 2A and 2B and the like, in the brightness correction enhancement along with the back light dimming, luminance enhancement results in a loss of contrast in the highlight portion. In other words, as schematically shown in FIGS. 6A-1 and 6A-2, when a pre-correction luminance histogram HTA-1 is corrected to a histogram HTA-2, a highlight portion indicated by HA-1 is destructed on a high luminance side, as indicated by HA-2.

However, the embodiment can perform dynamic range compression by contrast correction, thereby improving image quality in the brightness correction enhancement. Specifically, as schematically shown in FIGS. 6B-1 to 6B-3, the pre-correction histogram HTA-1 is corrected to a histogram HTA-3 by contrast correction. In this case, a dynamic range between LA-1 and HA-1 is compressed to a dynamic range between LA-3 and HA-3. Then, when the histogram HTA-3 is corrected to a histogram HTA-4 by the brightness correction enhancement, a contrast in a highlight portion is not lost as indicated by HA-4, even when the dynamic range is again expanded between LA-4 and HA-4. Accordingly, while maintaining good image quality, backlight dimming can be performed and also power consumption can be reduced.

In addition, simply performing a correction for compressing the dynamic range (such as a correction in which there is a one-to-one relationship between each luminance value and a correction value on the histogram) causes contrast deterioration. In other words, for example, rounding of luminance values after the dynamic range compression results in loss of gradation level difference.

In this respect, in the embodiment, a correction value is obtained by using the local average luminance value. Thus, contrast correction can be performed preserving a local contrast of the displayed image, thereby enabling the dynamic range compression to be performed without causing contrast deterioration of the displayed image.

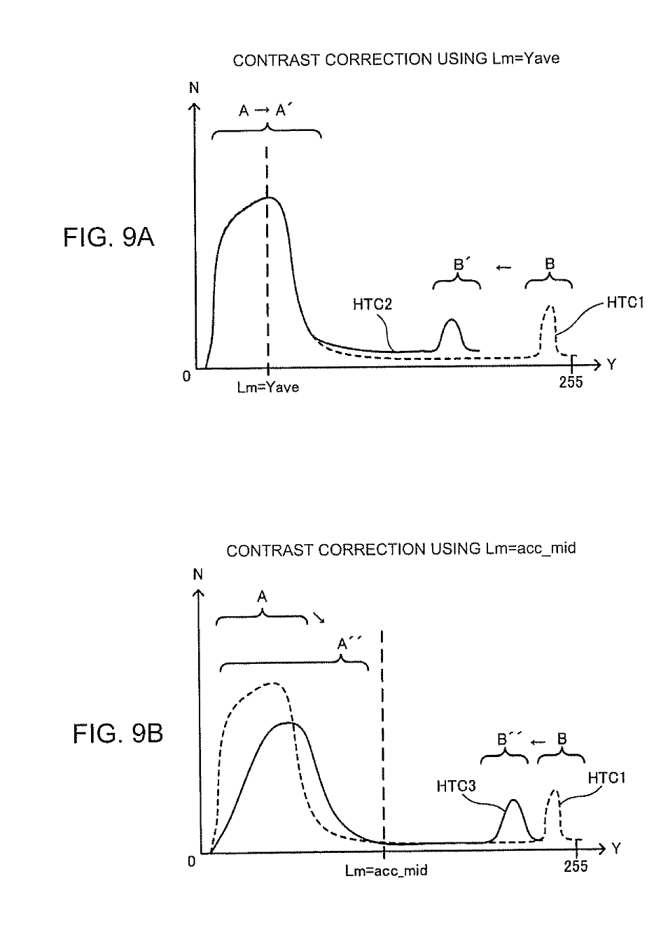

FIGS. 6B-1 to 6B-3 show the histograms to illustrate the contrast correction. However, since the correction uses the local average luminance value as mentioned above, there is not a one-to-one relationship between luminance values before and after the correction. That is, for example, a plurality of pixels having a same luminance on the histogram HTA-1 do not necessarily have a same luminance on the histogram HTA-3 after the correction. This applies to FIGS. 9A, 9B, and the like.

3. Brightness Index

For the contrast correction by the image processor of the embodiment, various values can be used as the brightness index Lm. In addition, characteristics of the contrast correction can be determined depending on what kind of value is used. For example, as will be described later, the average luminance Yave of a displayed image may be used as the brightness index Lm. However, using the average luminance Yave makes it difficult to obtain advantageous effects of correction, when distribution of luminance values on histograms deviates to a low or high level side.

FIG. 7 shows a specific example of the brightness index Lm allowing the above problem to be solved. In the example, the brightness index Lm is obtained by using a shadow pixel group SG and a highlight pixel group HG. First, the statistic-data acquiring section 20 acquires a histogram HTB regarding luminance values of pixels included in a displayed image to obtain the shadow pixel group SG and the highlight pixel group HG from the histogram HTB.

The shadow pixel group SG includes pixels in a range until an integrated value obtained by integrating luminance values in ascending numeric order on the histogram reaches a first threshold value ACC_MINTH. Specifically, a maximum luminance value k satisfying a following formula (1) is obtained, and then, pixels with a luminance value equal to or lower than the maximum luminance value k are included in the shadow pixel group SG. In the formula (1), symbols j and k each represent an integer equal to or larger than 0, a symbol N(j) represents a number of pixels with a luminance value j among pixels used by the statistic-data acquiring section 20 to acquire statistic data.

$${\sum }_{j = 0}^{k} N ( j ) < ACC\_MINTH \qquad ( 1 )$$

On the other hand, the highlight pixel group HG includes pixels in a range until an integrated value obtained by integrating luminance values in descending numeric order on the histogram reaches a second threshold value ACC_MAXTH. Specifically, a maximum luminance value k satisfying a following formula (2) is obtained, and then, pixels with a luminance value equal to or higher than the maximum luminance value k are included in the highlight pixel group HG.

$${\sum }_{j = 0}^{k} N ( 255 - j ) < ACC\_MAXTH \qquad ( 2 )$$

The statistic-data acquiring section 20 acquires a first index acc_min corresponding to the shadow pixel group SG and a second index acc_max corresponding to the highlight pixel group HG. Specifically, the first index acc_min is a maximum luminance value among luminance values of the pixels included in the shadow pixel group SG. In addition, the second index acc_max is a minimum luminance value among luminance values of the pixels included in the highlight pixel group HG.

Next, the brightness index computing section 30 receives the first and the second indexes to compute and output the brightness index Lm. For example, the brightness index computing section 30 can output, as the brightness index Lm, an index acc_mid that is an average value of the first index acc_min and the second index acc_max. In other words, the brightness index computing section 30 can obtain the index acc_mid from a following formula (3) to output the obtained index as the brightness index Lm.

$$acc\_mid = \frac{1}{2} ( acc\_min + acc\_max ) \qquad ( 3 )$$

The statistic-data acquiring section 20 may obtain the first and the second indexes acc_mix and acc_max by assigning a different value to each of the threshold values ACC_MINTH and ACC_MAXTH. In addition, the brightness index computing section 30 may obtain the index acc_mid by assigning a different weight to each of the first and the second indexes.

Using the brightness index Lm obtained as above enables contrast correction to be evenly performed on the highlight portion and the shadow portion of the displayed image.

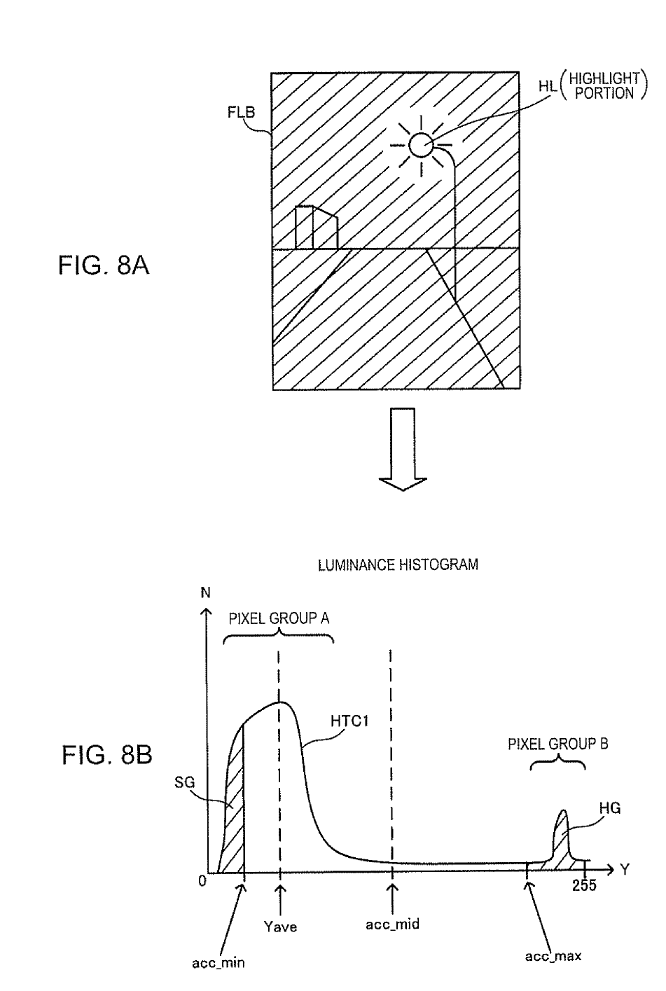

A detailed description will be given based on an image example of FIG. 8A. In FIG. 8A, a major part of a displayed image FLB is displayed as a dark region, and at a part on the screen, there is an extremely bright region (a highlight portion HL). Such an image may be a street light image as the displayed image FLB, a night view image, a fire work image, or the like.

FIG. 5B schematically shows a histogram HTC-1 of luminance of the displayed image FLB. The histogram HTC-1 includes a pixel group A corresponding to the major dark region of the image and a pixel group B corresponding to the highlight portion HL. Most of pixels included in the displayed image FLB belong to the pixel group A, and thus, the histogram HTC-1 has a shape deviating to the pixel group A rather than to the pixel group B. In this case, for example, the indexes acc_mix and acc_max are determined as shown in FIG. 8B. Thus, those indexes are determined corresponding to the shadow pixel group SG and the highlight pixel group HG, so that the index acc_mid is set as a luminance value between the pixel groups A and B. Meanwhile, an average luminance value Yave of the histogram HTC-1 is a luminance value near the pixel group A including most of the pixels in the displayed image.

Meanwhile, when using the average luminance Yave as the brightness index Lm, contrast of an image such as the displayed image FLB cannot be appropriately corrected. The case will be described below with reference to FIG. 9A.

FIG. 9A shows an example of contrast correction using a comparative example of the brightness index Lm. FIG. 9A is a schematic diagram showing an example of contrast correction of the displayed image FLB by using the average luminance Yave as the brightness index Lm. The average luminance Yave is acquired by the statistic-data acquiring section 20 using a following formula (4). In the formula (4), the symbol j represents an integer equal to or larger than 0; an expression (Tx×Ty) represents a total number of pixels used by the statistic-data acquiring section 20 to acquire statistic data; and the symbol N(j) represents the number of pixels with a luminance value j among the pixels used.

$$Yave = {\sum }_{j = 0}^{\text{?}} j \times N ( j ) / ( Tx \times Ty ) \\ \text{?} \text{indicates text missing or illegible when filed} \qquad ( 4 )$$

As shown in FIG. 9A, the image processor of the embodiment performs contrast correction of the displayed image FLB, whereby the histogram HTC-1 is converted to an histogram HTC-2, in which the pixel group A is shifted to a pixel group A′ and the pixel group B is shifted to a pixel group B′. As described above, since contrast correction is performed using the brightness index Lm as the midpoint, the correction from the pixel group A near the brightness index Lm to the pixel group A′ needs only a small shift between both of a high luminance side and a low luminance side. Meanwhile, since the pixel group B on the high luminance side is far from the brightness index Lm, the correction from the pixel group B to the pixel group B′ needs a large shift to the low luminance side. That is, in the example of FIG. 9A, correction effect on the pixel group A is small, whereas the correction results in excessive for the pixel group B. Accordingly, the dynamic range compression of the luminance also becomes excessive only for the high luminance side.

Thus, when the average luminance Yave is used as the brightness index Lm, contrast correction cannot be evenly performed on the high-luminance image region and the low-luminance image region of the displayed image where the luminance distribution is deviated.

However, the embodiment uses the index acc_mid as the brightness index Lm, whereby contrast correction can be performed evenly on the high and the low luminance image regions of the displayed image, regardless of the deviating luminance distribution.

FIG. 9B is a schematic diagram showing an example of contrast correction of the displayed image FLB using the index acc_mid as the brightness index Lm. As shown in the drawing, contrast correction of the displayed image FLB by the embodiment allows the histogram HTC-1 to be converted to an HTC-3 and allows the pixel groups A and B, respectively, to be shifted to pixel groups A′ and B′, respectively. A luminance value indicated by the index acc_mid is between the pixel groups A and B. Thereby, as compared to FIG. 9A, there can be obtained a sufficient correction effect on the pixel group A and the correction for the pixel group B is not excessively performed. In addition, the dynamic range of the luminance can be compressed evenly on the low and the high luminance sides.

In this manner, the image processor of the embodiment can perform appropriate contrast correction by using the index acc_mid as the brightness index Lm. In other words, the brightness index Lm is determined based on the index acc_min corresponding to the shadow pixel group and the index acc_max corresponding to the highlight pixel group, whereby contrast correction can be evenly performed on the low and the high luminance regions of the displayed image.

For low-quality images such as images underexposed due to backlighting, contrast needs to be improved. Meanwhile, for originally high-quality images, influence of correction needs to be maximally suppressed. For example, there may be mentioned an image such as an ordinary daytime scenic shot, in which many regions of the image have intermediate luminance and sufficient gradation levels. In this case, a luminance histogram of the image shows that most pixels are distributed on an intermediate luminance region, and thus there is no deviation in luminance distribution.

Regarding a displayed image as described above, in the present embodiment, pixels at opposite ends of a group of the pixels distributed on the intermediate luminance region are equivalent to the shadow pixel group and the highlight pixel group. Accordingly, the brightness index Lm is set around a center of the distribution of the pixels. Then, when the local average luminance value is close to the brightness index, a correction value is made small, thereby preventing the pixel distribution from being destroyed by contrast correction. In this manner, contrasts of low-quality images can be improved, as well as high-quality images can maintain the quality as it is.

4. Detailed Structural Example

4-1. Contrast Correction

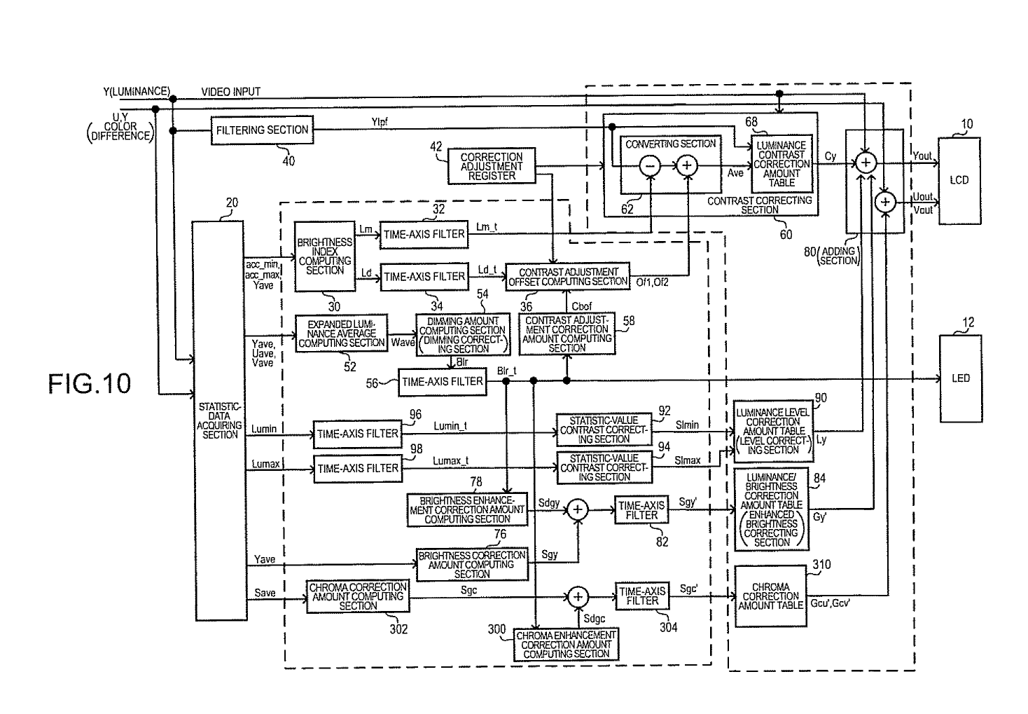

FIG. 10 shows a detailed structural example of the image processor of the embodiment. The image processor includes the statistic-data acquiring section 20, the filtering section 40, the brightness index computing section 30, time-axis filters 32, 34, a contrast adjustment correction amount computing section 58, a contrast adjustment offset computing section 36, a correction adjustment register 42, the contrast correcting section 60, and the adding section 80.

Specifically, the statistic-data acquiring section 20 acquires statistic data from a displayed image. Based on the statistic data, the filtering section 40, the brightness index computing section 30, and the contrast correcting section 60 perform contrast correction adaptively in accordance with the displayed image. In addition, the contrast adjustment correction amount computing section 58, the contrast adjustment offset computing section 36, and the correction adjustment register 42 perform offset adjustment of the contrast correction. The adding section 80 adds a correction value to image data of a target pixel.

More specifically, the statistic-data acquiring section 20 receives a luminance Y of the displayed image, a color difference U (a color difference Cb) of the image, and a color difference V (a color difference Cr) of the image to output, as the statistic data, the indexes acc_min and acc_max, the average luminance Yave, average color differences Uave and Vave, and indexes Lumin and Lumax. The statistic-data acquiring section 20 also converts the luminance Y and the color differences U, V to chroma S to output an average chroma Save as the statistic data. The statistic data output is acquired for each frame of a moving image. The average color differences Uave, Vave and the average chroma Save represent average values of the color differences U, V and the chroma S of the displayed image and are acquired in the same manner as in the average luminance Yave shown in the above formula (4). The indexes Lumin and Lumax, respectively, represent luminance values of pixels with a minimum luminance and luminance values of pixels with a maximum luminance, respectively. For example, the statistic-data acquiring section 20 can acquire the statistic data by using a power-of-two number of pixels included in the displayed image.

The filtering section 40 receives the luminance Y to output the local average luminance value Ylpf corresponding to a target pixel. Specifically, the filtering section 40 performs a filtering processing shown by a following formula (5). In the formula (5), symbols n and m each represents a natural number and symbols s and t each represents an integer. In addition, an expression Y (x+s, y+t) represents a luminance value of a pixel at coordinates (x+s, y+t), and an expression Y (x, y) represents a luminance value of the target pixel. Furthermore, a region of (2n+1) pixels×(2m+1) pixels mainly including target pixels is equivalent to a target pixel region. In the formula (5), changing the values of n and m according to a resolution of a displayed image (e.g. VGA or QVGA) enables the same correction effect to be obtained in images having a different resolution.

$$Ylpf = ( {\sum }_{\text{?}}^{m} {\sum }_{\text{?}}^{n} Y ( x + s , y + t ) ) / ( ( 2 n + 1 ) \times ( 2 m + 1 ) ) \\ \text{?} \text{indicates text missing or illegible when filed} \qquad ( 5 )$$

The brightness index computing section 30 receives the indexes acc_mix, acc_max and the average luminance Yave to output the brightness index Lm and a brightness difference value Ld. A following formula (6) shows the brightness index Lm. Specifically, the brightness index computing section 30 outputs, as the brightness index Lm, a threshold value acc_hth when the index acc_mid shown in the formula (3) is larger than the threshold value acc_hth. In addition, when the index acc_mid is smaller than a threshold value acc_{—}1th, the brightness index computing section 30 outputs the threshold value acc_{—}1th as the brightness index Lm. When the index acc_mid is equal to or larger than the threshold value acc_{—}1th and equal to or smaller than the threshold value acc_hth, the brightness index computing section 30 outputs the index acc_mid as the brightness index Lm. A following formula (7) shows the brightness difference value Ld, which is an absolute value of a difference between the brightness index Lm and the average luminance Yave and is used for offset adjustment in contrast correction described below. For example, when the brightness difference value Ld becomes large, contrast correction at low luminance is enhanced.

$$\begin{matrix}Lm = \{ \begin{matrix}if ( acc\_mid > acc\_hth ) acc\_hth \\ if ( acc\_mid < acc\_lth ) acc\_lth \\ else acc\_mid\end{matrix} & ( 6 ) \\ Ld = \vert Lm - Yave \vert & ( 7 )\end{matrix}$$

The time-axis filters 32 and 34 are disposed to prevent visual flickering caused by a radical change in the contrast correction value Cy. For example, the time-axis filters 32 and 34 prevent the correction value Cy from being radically changed in response to changes of scenes in an animation.

Specifically, the time-axis filter 32 receives the brightness index Lm to output a brightness index Lm_t. Since the brightness index Lm is determined for each frame of an animation, the time-axis filter 32 performs low-pass filtering of the brightness index Lm input in time sequence in each frame of the animation to output the brightness index Lm_t. The time-axis filter 34 receives the brightness difference value Ld to output a brightness difference value Ld_t. Similarly to the time-axis filter 32, the time-axis filter 34 performs low-pass filtering of the brightness difference value Ld input in time sequence in each frame of the animation to output the brightness difference value Ld_t. The time-axis filters 32 and 34 each may be an infinite impulse response (IIR) low-pass filter.

The correction adjustment register 42 determines a register value for adjusting intensity of contrast correction and a register value for adjusting an offset value of the contrast correction. Specifically, the correction adjustment register 42 outputs register values R_AH and R_AL to the contrast correcting section 60, and also outputs register values R_OL, R_OH, R_BH, R_FL and R_FH to the contrast adjustment offset computing section 36.

The contrast adjustment correction amount computing section 58 receives a dimming amount Blr_t of backlight dimming to output a dimming amount offset Cbof, which specifically becomes larger as a backlight dimming rate obtained by the dimming amount Blr_t increases.

The contrast adjustment offset computing section 36 receives the brightness difference value Ld_t, the dimming amount offset Cbof, and the register values R_OL, R_OH, R_BH, R_FL and R_FH to output a first offset Of-1 and a second offset Of-2. Specifically, the contrast adjustment offset computing section 36 computes the offset Of-1 according to a following formula (8) and computes the offset Of-2 according to a following formula (9). The offsets Of-1 and Of-2 are adjusted by the register values R_OL and R_OH. Components dependent on the brightness difference value Ld_t in the offsets Of-1 and Of-2 are adjusted by the register values R_FL and R_FH. In the offset Of-2, a component dependent on the dimming amount offset Cbof is adjusted by the register value R_BH.

Of 1=Ld_{—}t×R_{—}FL+R_{—}OL (8)

Of 2=Ld_{—}t×R_{—}FH÷R_{—}OH+Cbof×R_{—}BH (9)

The contrast correcting section 60 receives the local average luminance value Ylpf, the luminance Y of the target pixel, the brightness index Lm_t, the offsets Of-1 and Of-2, and the register values R_AH and R_AL to output a correction value Cy. Specifically, the contrast correcting section 60 includes a converting section 62 and a luminance contrast correction amount table 68.

More specifically, the contrast correcting section 60 obtains a local average luminance value Ylpf′ shown in a following formula (10). When an absolute value of a difference value between the target pixel luminance Y and the local average luminance value Ylpf is smaller than a threshold Ylth (a predetermined value), the target pixel luminance Y is used as the local average luminance value Ylpf′, and otherwise, the local average luminance value Ylpf is used as the local average luminance value Ylpf′.

$${Ylpf}^{ ′} = \{ \begin{matrix}if ( \vert Y - Ylpf \vert < Ylth ) Y \\ else Ylpf\end{matrix} \qquad ( 10 )$$

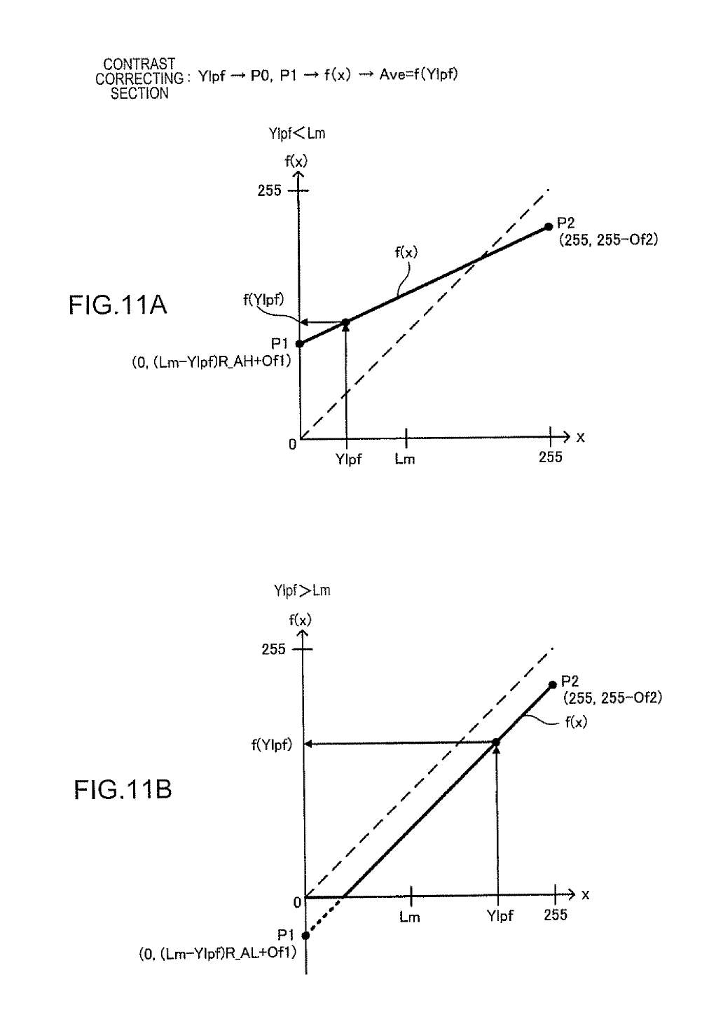

The converting section 62 receives the local average luminance value Ylpf′, the brightness index Lm_t, the offsets Of-1 and Of-2, and the register values R_AH and R_AL to output a converted local average luminance value Ave. Specifically, the converting section 62 performs conversion of the local average luminance value Ylpf′ using the brightness index Lm_t to output the converted local average luminance value Ave. More specifically, the converting section 62 obtains a point P1 shown in a following formula (11) and a point P2 shown in a following formula (12), and then, obtains the converted local average luminance value Ave shown in a following formula (13) from a straight line f(X) connecting the points P1 and P2. FIG. 11A shows a conversion example when the local average luminance value Ylpf′ is smaller than the brightness index Lm_t, and FIG. 11B shows a conversion example when the Ylpf′ is larger than the Lm_t. As shown in FIGS. 11A and 11B, the converting section 62 obtains the P1 and the P2 and thereby, the corresponding straight line f(X) is determined. Then, a point f(Ylpf′) corresponding to the local average luminance value Ylpf′ in the straight line f(X) is output as the converted local average luminance value Ave. In this case, as shown in FIG. 11B, the f(X) is set to 0 in a region where the line connecting the P1 to the P2 is equal to or less than 0.

$$\begin{matrix}P 1 = \{ \begin{matrix}if ( Lm < {Ylpf}^{ ′} ) \\ ( 0 , ( Lm - {Ylpf}^{ ′} ) \times R\_AH + Of 1 ) \\ else \\ ( 0 , ( Lm - {Ylpf}^{ ′} ) \times R\_AL + Of 1 )\end{matrix} & ( 11 ) \\ P 2 = ( 255 , 255 - Of 2 ) & ( 12 ) \\ Ave = f ( {Ylpf}^{ ′} ) & ( 13 )\end{matrix}$$

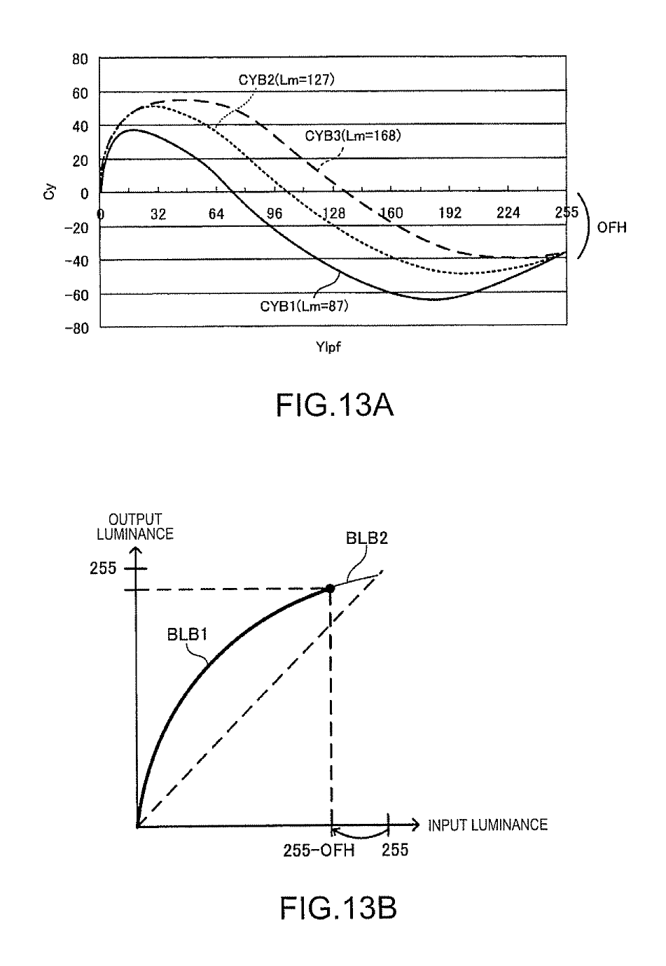

The luminance contrast correction amount table 68 receives the converted local average luminance value Ave and the local average luminance value Ylpf′ to output a correction value Cy, which is specifically shown in a formula (14). More specifically, the correction value Cy is obtained from a difference value between a value dependent on a ratio of the local average luminance value Ylpf′ and the converted local average luminance value Ave shown in a first term (γ: a local variable) of a following formula (14) and the local average luminance value Ylpf′. For example, a value of γ in the formula (14) is 2.2. Thereby, for example, correction values Cy shown by graph lines CYA-1 to CYA-3 in FIG. 12 and correction values Cy shown by graph lines CYB-1 to CYB-3 in FIG. 13 are output. The luminance contrast correction amount table 68 may be a lookup table.

$$Cy = Ave \times {( \frac{{Ylpf}^{ ′}}{Ave} )}^{\frac{1}{γ}} - {Ylpf}^{ ′} \qquad ( 14 )$$

The adding section 18 receives the luminance Y of the target pixel, the color differences U and V of the pixel target, and correction values Cy, Ly, Gy′, Gcu′, and Gcv′ to output an output luminance Yout and output color differences Uout, Vout. Specifically, the adding section 80 adds the target pixel luminance Y and the correction values Cy, Ly, and Gy′ to output the output luminance Yout (Y+Cy+Ly+Gy). In addition, the adding section 80 adds the target pixel color difference U and the correction value Gcu′ to output an output color difference Uout (U+Gcu′), and adds the target pixel color difference V and the correction value Gcv′ to output an output color difference Vout (V+Gcv′). In this case, the correction value Ly is a correction value of a level correction described below, and the correction values Gcu′, Gcv′ are correction values of color difference correction described below.

4-2. Backlight Dimming

The image processor of the embodiment can further include an expanded luminance average computing section 52, a dimming amount computing section 54, and a time-axis filter 56. Specifically, the statistic-data acquiring section 20 acquires statistic data of a displayed image, and then, the expanded luminance average computing section 52 and the dimming amount computing section 54 adaptively performs backlight dimming in accordance with the displayed image.

More specifically, the expanded luminance average computing section 52 receives the luminance average Yave and the chroma averages Uave, Vave to output an expanded luminance average Wave as a maximum value of the luminous average Yave, and the chroma averages Uave, Vave.

The dimming amount computing section 54 receives the expanded luminance average Wave to output the dimming amount Blr. In accordance with the dimming amount Blr, the backlight 12 (light emitting diode: LED) is subjected to luminance adjustment (dimming). Specifically, the dimming amount computing section 54 outputs the dimming amount Blr in which as the expanded luminance average Wave decreases, the backlight dimming rate increases.

When the dimming amount Blr is output using only the average luminance Yave, the backlight dimming rate in a dark image as a whole becomes large even if the image has a high chroma portion. Thereby, chroma reduction occurs, resulting in image quality deterioration. Thus, the expanded luminance average Wave is used to determine the backlight dimming rate. In other words, when the color difference average Uave or Vave is larger than the average luminance Yave, the dimming amount Blr is output in accordance with the color difference average Uave or Vave. Accordingly, in the case of a high-chroma displayed image, the backlight dimming rate becomes small, thereby preventing image quality deterioration.

The time-axis filter 56 prevents an occurrence of flickers. The flickers are caused by drastic changes in the dimming amount Blr associated with changes of scenes in an animation. Specifically, the time-axis filter 56 receives the dimming amount Blr and performs low-pass filtering thereof to output the dimming amount Blr_t.

4-3. Brightness Correction Enhancement

The image processor of the embodiment may include a brightness correction amount computing section 76, a brightness enhancement correction amount computing section 78, a time-axis filter 82, and a luminance/brightness correction amount table 84. Specifically, the statistic-data acquiring section 20 acquires statistic data of a displayed image, and based on the statistic data, the brightness correction amount computing section 76, the brightness enhancement correction amount computing section 78, and the luminance/brightness correction amount table 84 perform the enhanced image correction in the case of application of dimming, described in FIGS. 2A and 2B.

More specifically, the brightness correction amount computing section 76 performs brightness correction for the case of no dimming. That is, the brightness correction amount computing section 76 receives the average luminance Yave to output an output value Sgy corresponding to the correction value Gy for the case of no dimming.

The brightness enhancement correction amount computing section 78 performs brightness correction enhancement associated with dimming. Specifically, the brightness enhancement correction amount computing section 78 receives the dimming amount Blr_t to output an output value Sdgy corresponding to the increase ΔGy in the image correction value enhancement associated with dimming.

The time-axis filter 82 prevents a drastic change of the correction value Gy′ associated with scene changes. Specifically the time-axis filter 82 receives an added value of the output value Sgy input in each frame of a displayed image and the output value Sdgy to perform low-pass filtering of the added value so as to output an output value Sgy′.

The luminance/brightness correction amount table 84 receives the output value Sgy′ to output the correction value Gy′ (a second correction value). Specifically, based on the correction value Gy′ (Gy+ΔGy), the enhanced image correction in the case of application of dimming described in FIG. 2 is performed.

4-4. Level Correction

The image processor of the embodiment includes time-axis filters 96, 98, statistic-value contrast correcting sections 92, 94, and a luminance level correction amount table 90 (a level correcting section). Specifically, after receiving statistic data of a displayed image acquired by the statistic-data acquiring section 20, the statistic-value contrast correcting sections 92, 94, and the luminance level correction amount table 90 perform adaptive level correction in accordance with the displayed image.

More specifically, the time-axis filters 96 and 98 prevents radical changes of the correction value Ly associated with scene changes. Specifically, the time-axis filter 96 receives an index Lumin and performs low-pass filtering of the received index to output an index Lumin_t. The time-axis filter 98 receives an index Lumax and performs low-pass filtering of the received index to output an index Lumax_t. The indexes Lumin and Lumax, respectively, are a luminance value of a minimum-luminance pixel and a luminance value of a maximum-luminance pixel, respectively.

The statistic-value contrast correcting sections 92 and 94, respectively, optimize a luminance level of a low-luminance side and of a high-luminance side, respectively, on a luminance histogram. Specifically, the statistic-value contrast correcting section 92 receives the Lumin_t to output an output value Slmin, whereas the statistic-value contrast correcting section 94 receives the Lumax_t to output an output value Slmax.

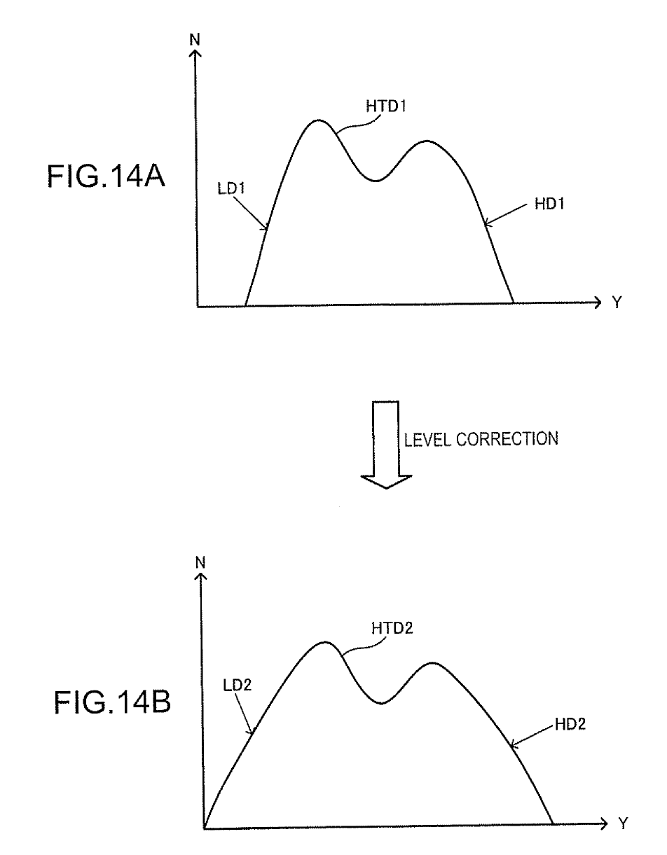

The luminance level correction amount table 90 receives the output values Slmin and Slmax to output a correction Ly. Specifically, based on the correction value Ly, level correction of the displayed image is performed. More specifically, as schematically shown in FIGS. 14A and 14B, based on the correction value Ly, a histogram HTD-1 is corrected to a histogram HTD-2. That is, a low-luminance portion of the histogram HTD-1 indicated by LD-1 is expanded in a low-luminance direction as indicated by LD-2, whereas a high-luminance portion of the histogram HTD-1 indicated by HD-1 is expanded in a high-luminance direction as indicated by HD-2. This allows the luminance levels of the low and the high luminance sides on the luminance histogram to be optimized.

4-5. Chroma Correction

The structural example of the image processor of the embodiment in FIG. 10 may include a chroma correction amount computing section 302, a chroma enhancement correction amount computing section 300, a time-axis filter 304, and a chroma correction amount table 310. Specifically, the statistic-data acquiring section 20 acquires statistic data from a displayed image, and the chroma correction amount computing section 302, the chroma enhancement correction amount computing section 300, and the chroma correction amount table 310 receive the statistic data to perform chroma correction (chroma enhancement) adaptively in accordance with the displayed image.

More specifically, the chroma correction amount computing section 302 performs the chroma correction in the case of backlight dimming. That is, the chroma correction amount computing section 302 receives the chroma average Save to output an output signal Sgc corresponding to a chroma correction value in the case of no backlight dimming.

The chroma enhancement correction amount computing section 300 performs enhanced chroma correction due to backlight dimming. Specifically, the chroma enhancement correction amount computing section 300 receives the dimming amount Blr_t to output an output value Sdge corresponding to an amount of the enhanced chroma correction due to backlight dimming.

The time-axis filter 304 prevents drastic changes of the correction values Gcu′ and Gcv′ associated with changes of the displayed image. Specifically the time-axis filter 304 receives an added value of the output value Sgc and Sdgc and perform low-pass filtering of the added value to output an output value Sgc′.

The chroma correction amount table 310 receives the output value Sgc′ to output the enhanced chroma correction values Gcu′ and Gcv′ in the case of application of backlight dimming. Specifically, there can be obtained equations: Gcu′=Gcu+ΔGcu and Gcv′=Gcv+ΔGcv. The Gcu and Gcv each represent a chroma correction value in the case of no backlight dimming, and the ΔGcu and the ΔGcv each represent an increase in chroma correction enhancement associated with the backlight dimming. For example, the correction value Gcu′ is a negative correction value when the color difference U is negative, whereas the Gcu′ is a positive correction value when the U is positive. Thereby, chroma of the displayed image is enhanced. In addition, the ΔGcu and the ΔGcv allow the chroma of the displayed image to be more enhanced as the backlight dimming rate becomes larger.

The luminance level correction amount table 90, the luminance/brightness correction amount table 84, and the chroma correction amount table 310 may be look-up tables, for example. Additionally, the time-axis filter 56, 82, 96, and 98 may be IIR low-pass filters, for example.

The image processor of the embodiment is not restricted to the structural example of FIG. 10, and for example, may be used by omitting a part of the structure, such as the time-axis filters 32, 34, 56, 82, 96, and 98.

5. Specific Example of Contrast Correction

5-1. Specific Example of Correction Value Cy

A specific example of the correction value Cy output from the contrast correcting section 60 will be described with reference to FIG. 12 and FIGS. 13A and 13B.

FIG. 12 shows a first specific example of the correction value Cy, when the first and the second offsets Of-1 and Of-2 are both equal to 0. For example, in graph lines CYA-1 and CYA-2, at each of portions indicated by CA-1 and CA-2, the correction value Cy increases as the local average luminance value Ylpf increases. That is, at a shadow portion and a highlight portion of a displayed image, the correction value Cy allows contrast to be enhanced. Additionally, as shown in graph lines CYA-1 to CYA-3, the correction value Cy is a positive value when the Ylpf′ is smaller than the Lm_t, whereas the Cy is a negative value when the Ylpf′ is larger than the Lm_t. Thus, the correction value Cy allows the dynamic range of the displayed image to be compressed.

FIG. 13A shows a second specific example of the correction value Cy, when the offset Of-2 is not equal to 0. As shown in graph lines CYB-1 to CYB-3, the Of-2 generates an offset OFH on a high-luminance side of the correction value Cy. The offset OFH can more effectively prevent highlight loss due to brightness correction enhancement.

The effect of the offset OFF will be described with reference to FIG. 13B. Graph lines BLB-1 and BLB-2 show the correction by the correction value Gy′ including ΔGy as the increase in the brightness correction enhancement shown in FIG. 2A. As shown in FIG. 13B, when the luminance values range from 0 to 255, luminance correction is performed in a range of 0 to (255—OFH) using the correction value Cy with the offset OFH. Then, in the correction by the correction value Gy′, the luminance is corrected in a range shown by the BLB-1. Accordingly, brightness correction enhancement can be performed excluding a range indicated by the BLB-2 where contrast of the highlight portion is lost.

On the other hand, in order to prevent image quality deterioration due to brightness correction enhancement, dynamic range compression as well as contrast correction is needed. It is also necessary to improve image quality of a shadow portion in a photo taken with backlighting or the like.

Regarding the problems, the image processor of the embodiment can output a correction value Cy for increasing the luminance value of a target pixel when the local average luminance value Ylpf is smaller than the brightness index Lm. In addition, when the Ylpf is larger than the Lm, the image processor can perform contrast correction for reducing the luminance value of the target pixel. Furthermore, contrast correction can be performed using a correction value Cy whose absolute value increases as an absolute value of the difference between the Lm and the Ylph increases. The contrast correction can be accomplished by the contrast correcting section 60, the converting section 62, and the luminance contrast correction amount table 68 in the structural example of FIG. 10. Specifically, the above contrast correction can be performed by using the formulas (11) to (14), and may be performed using the correction value Cy shown in FIG. 12 and FIG. 13A.

In this manner, contrast correction can be performed to improve the contrast of a displayed image. Specifically, as shown in FIG. 12 and the like, image quality can be improved by enhancement of contrast in the shadow portion and the highlight portion of the displayed image. Furthermore, dynamic range compression can be achieved without deteriorating the contrast of the displayed image.

In addition, in the embodiment, when the local average luminance value Ylph is smaller than the brightness index Lm, conversion processing is performed that allows the converted local average luminance value Ave to be larger than the Ylpf. Conversely, when the Ylpf is larger than the Lm, conversion processing performed allows the Ave to be smaller than the Ylph. This can be accomplished by the converting section 62 in the structural example of FIG. 10 and the formulas (11) to (13). Specifically, the conversion processings can be accomplished by the conversion examples shown in FIGS. 11A and 11B.

In this manner, the embodiment can provide the correction value Cy that allows the dynamic range of the displayed image to be compressed without deteriorating the contrast of the image.

Additionally, the image processor of the embodiment can set a first correction intensity corresponding to the local average luminance value Ylpf having a higher luminance level than the brightness index Lm and a second correction intensity corresponding to the Ylpf′ having a lower luminance level than the brightness index Lm. The above correction intensities can be set using the register value R_AH (the first correction intensity) and the register value R_AL (the second correction intensity).

Thus, register setting allows contrast correction intensity to be set. Furthermore, the contrast correction intensity can be independently set on the low- and the high-luminance regions of a displayed image.

Specifically, the image processor of the embodiment performs a processing of multiplying a difference value between the brightness index Lm and the local average luminance value Ylpf by the first correction intensity R_AH when the Ylph is larger than the Lm. Conversely, when the Ylph is smaller than the Lm, the image processor multiplies the difference value between the Lm and the Ylpf by the second correction intensity R_AL. The multiplication can be performed using the correction adjustment register 42 and the converting section 62 in the structural example of FIG. 10 and the formula (11).

Thereby, contrast correction intensity can be adjusted. In addition, the contrast correction intensity can be independently adjusted on each of the low- and the high-luminance regions of the displayed image. That is, the register value R_AH can enhance a high-luminance side of the correction value Cy, whereas the register value R_AL can enhance a low-luminance side of the correction value Cy.

In addition, the image processor of the embodiment includes a first offset for adjusting offset of the low-luminance side in the conversion processing and a second offset for adjusting offset of the high-luminance side in the conversion processing. Then, an offset adding processing is performed to add the first offset to a result obtained by multiplying the difference value (Lm−Ylpf′) by the correction intensities R_AH and R_AL. This can be achieved by the contrast adjustment offset computing section 36 and the converting section 62 in the structural example of FIG. 10, the first and the second offsets Of-1, Of-2, and the formulas (11), (12).

Thereby, offset of contrast correction can be adjusted. Furthermore, the offset adjustment can be performed independently on the low-luminance side and the high-luminance side. Specifically, the offset Of-1 can enhance the low-luminance side of the correction value Cy and can dim the high-luminance side thereof. In addition, the offset Of-2 can dim the low-luminance side of the correction value Cy and can enhance the high-luminance side thereof, as well as can adjust the offset OFH shown in FIGS. 13A and 13B. The offset OFH can more effectively prevent image quality deterioration due to brightness correction enhancement.

Specifically, in the embodiment, a first offset adjustment value and a second offset adjustment value can be set to output the offsets Of-1 and Of-2. This can be performed by the correction adjustment register 42 and the contrast adjustment offset computing section 36 in the structural example of FIG. 10, the register values R_OL and R_OH (the first and the second offset adjustment values), and the formulas (8), (9).

Thereby, offset adjustment for contrast correction can be accomplished by register setting, as well as the offset adjustment can be performed independently for each of the low-luminance side and the high-luminance side.

Furthermore, the embodiment can output offsets Of-1 and Of-2 using the brightness difference value Ld as the absolute value of the difference between the brightness index Lm and the average luminance Yave. This can be performed by the brightness index computing section 30, the contrast adjustment offset computing section 36, and the formulas (7), (8), and (9).

Thereby, contrast correction can be adjusted in a displayed image having a deviated distribution of luminance. For example, in the displayed image having the histogram deviated on the low-luminance side shown in FIG. 8B, the average luminance Yave is smaller than the brightness index Lm (=acc_mid), and thus, the brightness difference value Ld becomes large. Then, the offsets Of-1 and Of-2 obtained by the formulas (8) and (9) become large, whereby the low- and the high-luminance sides of the correction value Cy are both enhanced.

When the average luminance Yave is low, the backlight dimming rate increases, and thus, luminance enhancement by the brightness correction enhancement also increases. In this respect, the embodiment can enhance the correction value Cy by using the brightness difference value Ld. Thus, in the case of the low average luminance Ave, reducing the luminance of the highlight portion on a larger scale can prevent gradation loss of the highlight portion and can further enhance contrast of the low-luminance region including many pixels. Meanwhile, when the luminance distribution shows no deviation, the value of the brightness index Lm is close to the value of the average luminance Yave, and thus, the brightness difference value Ld is small. Accordingly, contrast can be enhanced only for a low-quality image having a deviated luminance distribution.

On the other hand, gradation difference can be lost when contrast correction is performed using the local average luminance value Ylpf on a low-gradation portion of the displayed image (for example, where a difference value between the luminance value of the target pixel and the local average luminance value is 0 or 1). In other words, the Ylpf as the average luminance of the target pixel region is equated on the low-gradation portion by rounding (for example, values Ylpf of 0.6 and 1.4, respectively, are rounded to 1 and 1, respectively. Furthermore, increasing computation precision to avoid equation of the Ylpf leads to an increase in circuit size.

As for the problems, in the embodiment, when the absolute value of the difference between the luminance value Y of the target pixel and the local average luminance value Ylpf is smaller than a predetermined value, the luminance value Y can be used instead of the Ylpf. This can be performed by the contrast correcting section 60, a threshold value Ylth (a predetermined value), and the formula (10).

Consequently, contrast correction enhancing contrast of the low gradation portion can be accomplished, contrary to when using only the local average luminance value Ylpf. Then, the loss of gradation difference in the low gradation portion can be prevented without increasing the computation precision of the Ylpfm thereby preventing an increase in the circuit size.

In addition, the image processor of the embodiment may include a dimming correcting section and a brightness enhancement correcting section. The dimming correcting section outputs a dimming amount to perform a dimming correction of illumination for image display in accordance with each displayed image. The brightness enhancement correcting section outputs the second correction value enhancing luminance based on the dimming amount. The dimming correcting section can be formed by the expanded luminance average computing section 52, the dimming amount computing section 54, and the time-axis filter 56. The brightness enhancement correcting section can be formed by the brightness correction amount computing section 76, the brightness enhancement correction amount computing section 78, the time-axis filter 82, and the luminance/brightness correction amount table 84.

The above structure can achieve image correction enhanced in accordance with backlight dimming, as described with reference to FIG. 1, FIGS. 2A, 2B, and the like. Specifically, the dimming amount computing section 54 can output the dimming amount Blr for dimming light of the backlight 12 (LED) illuminated for image display; the brightness correction amount computing section 76 can receive the dimming amount Blr to perform correction enhancement (luminance enhancement); and the luminance/brightness correction amount table 84 can output the second correction value Gy′. Thereby, backlight dimming can be performed while preventing image quality from being deteriorated by the enhanced image correction due to backlight dimming and contrast correction, thus enabling power consumption to be reduced.

5-2. Specific Example of Image Correction by the Embodiment

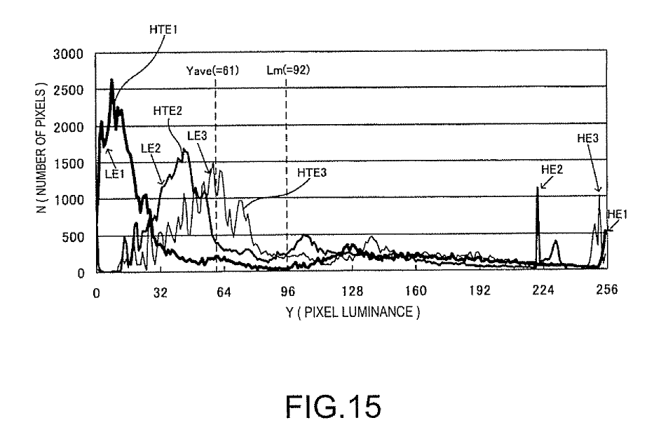

FIG. 15 shows a specific example of image correction by the image processor of the embodiment. For simple description, FIG. 15 illustrates a case in which the embodiment is applied to a static image example, although the embodiment may be applied to a moving image example to adaptively perform image correction of the image displayed.

FIG. 15 is a chart showing luminance histogram examples of an image obtained by applying the embodiment. An THE-1 is a histogram example of the image before correction; an THE-2 is a histogram example of the image after contrast correction; and an THE-3 is a histogram example of the image after image correction enhanced due to backlight dimming was performed in addition to the contrast correction.

First, with the contrast correction, a shadow portion indicated by an LE-1 is shifted in a high-luminance direction as indicated by an LE-2, and a highlight portion indicated by an HE-1 is shifted in a low-luminance direction as indicated by an HE-2. In this manner, as a result of the contrast correction, the dynamic range of the image is compressed. Next, with the image correction enhanced due to dimming, luminance is enhanced. In this case, as indicated by an HE-3, contrast loss of the highlight portion is prevented by the performed contrast correction. In addition, as indicated by the LE-2 and LE-3, contrast of the shadow portion is improved as compared to the LE-1, and as indicated by the HE-2 and HE-3, contrast of the highlight portion is improved as compared to the HE-1.

6. Image Display Control Device

6-1. Structural Example

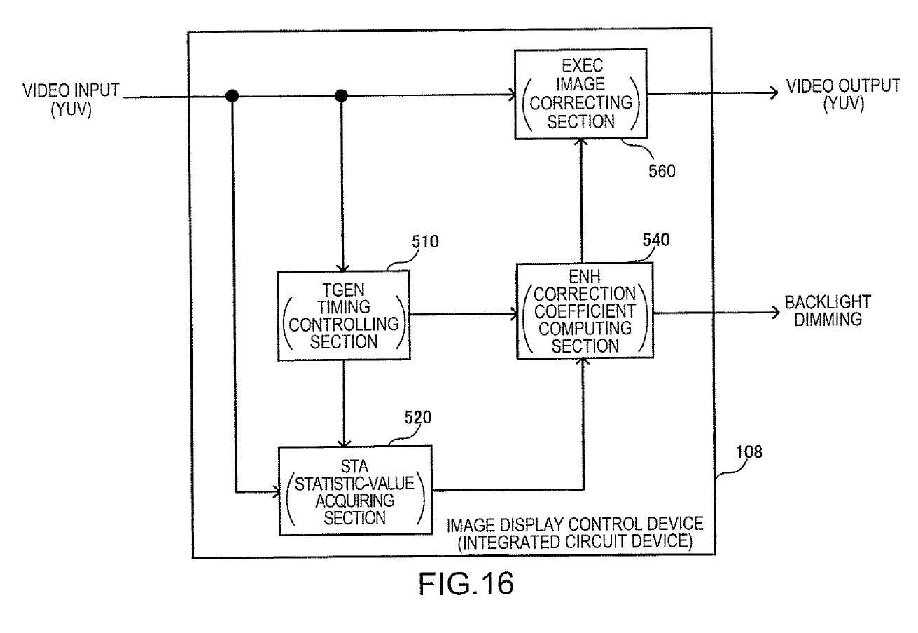

FIG. 16 shows a structural example of an image display control device (an integrated circuit device). The structural example shown includes a timing controlling section 510, a statistic-value acquiring section 520, a correction coefficient computing section 540, and an image correcting section 560.

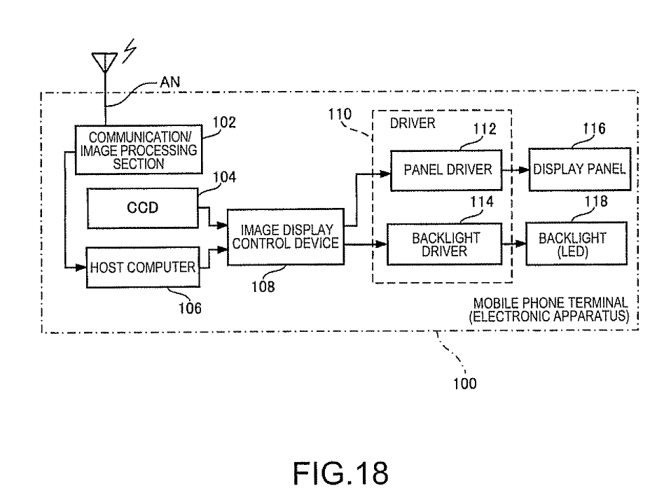

For example, the timing controlling section 510 extracts a synchronizing signal from a YUV image signal input from a host computer 106 shown in FIG. 18 to generate a timing signal indicating operation timing for each section.

The statistic-value acquiring section 520 receives the YUV image signal and the timing signal from the timing controlling section 510 to acquire statistic data of an image signal (relating to luminance, color difference, and chroma) for a single frame of a displayed image.

The correction coefficient computing section 540 receives the timing signal from the timing controlling section 510 and the statistic data from the statistic-value acquiring section 520 to calculate the correction values for image correction (such as Cy and Gy′) and a backlight luminance after dimming (the dimming amount Blr) in real time. Then, for example, the correction coefficient computing section 540 outputs the calculated dimming amount Blr to a backlight (LED) driver 114 shown in FIG. 18.

The image correcting section 560 receives the YUV image signal and the correction value for image correction input from the correction coefficient computing section 540 to perform image correction in synchronization with input of an image signal of a following frame. Thereafter, for example, the image correcting section 560 outputs a corrected image signal to a panel driver 112 shown in FIG. 18.

6-2. Detailed Structural Example

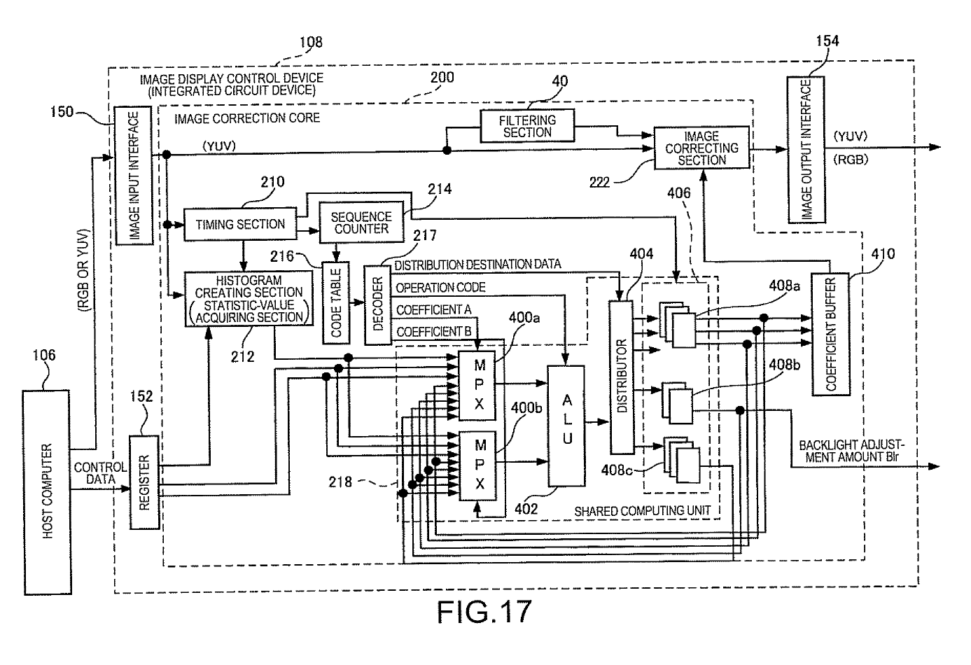

FIG. 17 is a diagram showing a detailed structural example.

In the drawing, for example, an image display control device 108 is incorporated in a mobile terminal (as an electronic apparatus such as a mobile phone terminal, a PDA terminal, or a mobilable computer terminal) shown in FIG. 18. The mobile terminal includes an antenna AN receiving one-segment broadcasting signals, a communication/image processing section 102, and the host computer 106. For example, the host computer 106 receives a streaming video signal to output to an image display control device 108.

As shown in FIG. 17, the image display control device 108 includes an image input interface (I/F) 150, a register 152, an image correction core 200, and an image output interface (I/F) 154. The image input I/F 150 receives an RGB image signal (a color signal) or a YUV signal (a luminance signal and a color difference signal) supplied from the host computer 106. When the received image signal is the RGB signal, the image input I/F 150 converts the RGB signal to a YUV image signal. The register 152 temporarily stores control data (such as the register values R_AH and R_AL) supplied from the host computer 106. The image correction core 200 performs image correction of the image signal. In addition, the image output I/F 154 converts the YUV image signal to an RGB image signal or outputs the YUV signal without converting to the color signal.

Hereinafter, a detailed description will be given of functions and operations of respective sections of the image correction core 200 in FIG. 17.

A timing section 210 extracts a synchronizing signal from the YUV image signal output from the image input I/F 150 to generate a timing signal indicating operation timing of each section.

A shared computing unit 218 includes a first multiplexer 400a, a second multiplexer 400b, an arithmetic logic unit (ALU) 402, a distributor 404 distributing a computation result of the ALU 402, and a plurality of destination registers 406. The destination registers 406 includes register groups composed of 408a to 408c divided for each destination. In addition, each feedback channel is provided to return at least a part of a computation result stored in each of the register groups 408a to 408c to input terminals of the first and the second multiplexers 400a and 400b.

A histogram creating section (the statistic-value acquiring section) 212 acquires statistic data of an image signal for a single frame (luminance-related statistic data and chroma-related statistic data).

A code table (a code storing section) 216 stores a plurality of micro codes for designating operation procedures of the shared computing unit 218.

A sequence counter (a sequence instructing section) 214 points at the code table 216 to control a sequence of the micro codes output from the code table 216. The decoder 217 decodes the micro codes sequentially output from the code table 216 to generate at least one of commands and data for supplying the decoded micro codes to the shared computing unit.

The decoder 217 supplies a coefficient used for computation to the first and the second multiplexers 400a and 400b, supplies a computation command (an operation code) to the ALU 402, and supplies destination data to the distributor 404.

The shared computing unit 218 calculates the correction values (such as Cy and Gy′) for image correction and backlight luminance after dimming (the dimming amount Blr) in real time. Computation of the shared computing unit 218 results in implementation of image processing by the contrast correction described using FIG. 3 and the like. In addition, there will be substantially performed the backlight dimming processing, image processing by the correction enhanced due to the backlight dimming, image processing by the chroma enhancing correction, and image processing by the level correction, which are described with reference to FIG. 10 and the like.

As described above, the computation of the shared computing unit 218 is controlled by the micro codes including coded signal processing steps. Using the shared computing unit having a minimum circuit structure allows real-time computation to be performed without same kinds of hardware disposed in parallel to each other. Thereby, with the minimum circuit and minimum power consumption, high-speed dimming control and image control can be accomplished.

The computation result of the shared computing unit 218 is temporarily stored in the register groups 408a to 408c divided for each destination. The calculated backlight luminance (the dimming amount Blr) is output to the backlight (LED) driver, and the correction values are stored in a coefficient buffer 410. The correction values stored in the coefficient buffer 410 are supplied to the image correcting section 222 in synchronization with input of an image signal of a following frame to perform image correction.

Additionally, at least a part of the calculation result stored in each of the register groups 408a to 408c is returned to the input terminals of the first and the second multiplexers 400a and 400b via the each feedback channels. Thereby, first, after backlight luminance after dimming is obtained, the calculation result is returned to the input terminals, and based on the obtained illumination luminance, processing for obtaining an image correction value is performed.

7. Mobile Phone Terminal

FIG. 18 is a diagram showing a structural example of a mobile phone terminal (an electronic apparatus). In the drawing, a mobile phone terminal 100 (an electronic apparatus) incorporates an image display control device (an image display control large scale integrated (LSI) circuit. The mobile phone terminal 100 includes the antenna AN, the communication/image processing section 102, a CCD camera 104, the host computer 106, the image display control device 108, a driver 110 (including the panel driver 112 and the backlight driver 114), a display panel 116 such as a liquid crystal panel (LCD), and a backlight (LED) 118.

The image display control device 108 may be a control LSI circuit as a discrete device from the driver 110 or may be incorporated in the driver 110. In addition, the image display control device 108 may be incorporated in a controller of the driver 110 or in a driving control device (formed by integrating a driver and a controller).

The image display control device 108 of the embodiment is characterized by real-time capabilities to process a moving image such as a streaming image, excellent low power consumption, and downsizability. Thus, including the image display control device 108 in the electronic apparatus 100 increases added value of the apparatus.

While the embodiment has been described in detail as above, it will be understood by those skilled in the art that many modifications may be made without substantially departing from the novel teachings and advantages of the invention. Thus, those modifications are all encompassed within the scope of the invention. For example, in the present specification and the drawings, any term (such as frame image, contrast compression, luminance contrast, and luminance index) cited with a different term having a broader meaning or the same meaning (such as displayed image, contrast correction, contrast, and brightness index) at least once can be replaced by the different term in any place in the specification and the drawings. Furthermore, the structures and the operations of the contrast correcting section, the brightness index computing section, the filtering section, the statistic-value acquiring section, the brightness enhancement correcting section, the dimming amount correcting section, the image processor, the integrated circuit device, and the electronic apparatus are not restricted to those described in the embodiment, and various modifications are possible.

What is claimed is:

1. An image processor, comprising:
a statistic-data acquiring section acquiring statistic data of a luminance value of a displayed image, the statistic-data acquiring section acquires, as the statistic data, a first index regarding a shadow pixel group and a second index regarding a highlight pixel group;
a brightness index computing section computing a brightness index of the displayed image based on the statistic data, the brightness index computing section computing the brightness index from the first and the second indexes;
a filtering section filtering luminance values of at least a part of a plurality of pixels included in a target pixel region of the displayed image to compute a local average luminance value; and
a contrast correcting section performing contrast correction of the displayed image based on the brightness index and the local average luminance value.

2. The image processor according to claim 1, wherein the first index is a maximum luminance value in a range where a value obtained by adding numbers of the pixels included in the displayed image in ascending numeric order of the luminance values does not exceed a first threshold value, and the second index is a minimum luminance value in a range where a value obtained by adding the numbers of the pixels included in the displayed image in descending numeric order of the luminance values does not exceed a second threshold value.

3. The image processor according to claim 1, wherein the brightness index is an average between the first index and the second index.

4. The image processor according to claim 1, further including an adding section adding the luminance value of each of the at least a part of the pixels included in the displayed image and a correction value; the target pixel region includes at least one target pixel of the displayed image; the contrast correcting section outputs a first correction value obtained from a difference between the brightness index and the local average luminance value; and the adding section adds a luminance value of the at least one target pixel and the first correction value.

5. The image processor according to claim 4, wherein when the local average luminance value is smaller than the brightness index, the contrast correcting section outputs, as the first correction value, a correction value that increases the luminance value of the at least one target pixel, whereas, when the local average luminance value is larger than the brightness index, the contrast correcting section outputs, as the first correction value, a correction value that decreases the luminance value of the at least one target pixel.

6. The image processor according to claim 5, wherein the contrast correcting section outputs, as the first correction value, a correction value whose absolute value increases as an absolute value of the difference between the brightness index and the local average luminance value increases.

7. The image processor according to claim 1, further including an adding section adding the luminance value of each of the at least a part of the pixels included in the displayed image and a correction value; the target pixel region is a region including at least one target pixel in the displayed image; the contrast correcting section includes a converting section performing a processing of converting the local average luminance value by using the brightness index to output a converted local average luminance value and outputs a first correction value by using the local average luminance value and the converted local average luminance value; and the adding section adds a luminance value of the at least one target pixel and the first correction value.

8. The image processor according to claim 7, wherein when the local average luminance value is smaller than the brightness index, the converting section performs the conversion processing such that the converted local average luminance value becomes larger than the local average luminance value, whereas, when the local average luminance value is larger than the brightness index, the converting section performs the conversion processing such that the converted local average luminance value becomes smaller than the local average luminance value.

9. The image processor according to claim 7, further including a correction adjustment register setting a first correction intensity corresponding to the local average luminance value having a higher luminance level than the brightness index and a second correction intensity corresponding to the local average luminance value having a lower luminance level than the brightness index.

10. The image processor according to claim 9, wherein when the local average luminance value is larger than the brightness index, the converting section multiplies a difference between the brightness index and the local average luminance value by the first correction intensity, whereas, when the local average luminance value is smaller than the brightness index, the converting section multiplies the difference between the brightness index and the local average luminance value by the second correction intensity.

11. The image processor according to claim 7, further including a contrast adjustment offset computing section outputting a first offset that adjusts an offset for a low-luminance side in the conversion processing and a second offset that adjusts an offset for a high-luminance side in the conversion processing.

12. The image processor according to claim 11, wherein the statistic-value acquiring section acquires an average luminance value of the displayed image as the statistic data; the brightness index computing section outputs a brightness difference value as an absolute value of a difference value between the brightness index and the local average luminance value; and the contrast adjustment offset computing section outputs the first offset and the second offset by using the brightness difference value.

13. The image processor according to claim 12, further including a correction adjustment register setting a first offset adjustment value and a second offset adjustment value, wherein the contrast adjustment offset computing section outputs the first offset by using the first offset adjustment value and outputs the second offsets by using the second offset adjustment value.

14. The image processor according to claim 13, wherein the correction adjustment register sets a first correction intensity corresponding to the local average luminance value having a higher luminance level than the brightness index and a second correction intensity corresponding to the local average luminance value having a lower luminance level than the brightness index; and the converting section performs a multiplication in which, when the local average luminance value is larger than the brightness index, the difference value between the brightness index and the local average luminance value is multiplied by the first correction intensity, whereas when the local average luminance value is smaller than the brightness index, the difference value between the brightness index and the local average luminance value is multiplied by the second correction intensity, so as to add a result of the multiplication to the first offset.

15. The image processor according to claim 4, wherein, when an absolute value of a difference value between the luminance value of the at least one target pixel and the local average luminance value is smaller than a predetermined value, the contrast correcting section uses the luminance value of the at least one target pixel instead of the local average brightness value.

16. The image processor according claim 4, further including a dimming correcting section outputting a dimming amount for performing dimming correction of image display lighting in accordance with the displayed image and a brightness enhancement correcting section outputting a second correction value for luminance enhancement based on the dimming amount, wherein the adding section adds the luminance value of the at least one target pixel to the second correction value.

17. An integrated circuit device including the image processor according to claim 1.

18. An electronic apparatus including the integrated circuit device according to claim 17.
